(19) United States
(12) Patent Application Publication
(10) Pub. No.: US 2016/0302352 A1
(43) Pub. Date: Oct. 20, 2016

(54) HIGH REDUNDANCY SEED COATING APPARATUS AND METHOD

(71) Applicants: Daniel Tramp, Sabetha, KS (US); Timothy A. Craft, Holton, KS (US); Austin Wasinger, Sabetha, KS (US); Andrew Renyer, Sabetha, KS (US)

(72) Inventors: Daniel Tramp, Sabetha, KS (US); Timothy A. Craft, Holton, KS (US); Austin Wasinger, Sabetha, KS (US); Andrew Renyer, Sabetha, KS (US)

(21) Appl. No.: 15/099,739

(22) Filed: Apr. 15, 2016

Related U.S. Application Data
(60) Provisional application No. 62/148,284, filed on Apr. 16, 2015.

(51) Int. Cl. A01C 1/06

(52) U.S. Cl. CPC A01C 1/06

(57) ABSTRACT

A system (1) and method for coating seeds with a treatment liquid, in which transfers of seeds and liquid within the system arc controlled by a control assembly (6) in accordance with selectable operational modes. Some modes involve determining an actual amount of a quantity and/or a subquantity of seeds transferred from a bin (24) based on a change in the weight of seeds remaining in the bin (24), and adjusting the system (1) to account for a difference between the actual and expected amounts. Other modes involve determining an actual amount of a quantity and/or a flowrate of liquid transferred from a tank (750) based on a change in the weight of liquid remaining in the tank (750), and adjusting the system (1) to account for a difference between the actual and expected amounts. Further, these modes can be performed together for even greater redundancy and accuracy.

### RELATED APPLICATIONS

The present non-provisional patent application is related to and claims priority benefit of an earlier-filed provisional application titled “High Redundancy Seed Coating Apparatus and Method”, Ser. No. 62/148,284, filed Apr. 16, 2015. The entire content of the identified earlier-filed application is hereby incorporated by reference into the present application.

### BACKGROUND OF THE INVENTION

1. Field of the Invention

The present invention is directed to improved seed coating systems and methods allowing users to select different modes of operation and control of the system components. More particularly, the invention is concerned with such apparatus and methods using a seed coating apparatus having a seed bin assembly, a seed metering wheel below the bin assembly, a liquid coating delivery assembly, and coating apparatus designed to receive seed and coat the seed with liquid. An electronic control assembly is employed to selectively operate the seed bin and liquid coating delivery assemblies in different modes, depending upon the desire of the operator and the conditions of seed treatment.

### SUMMARY OF THE INVENTION

A system and method for coating seeds with a treatment liquid, in which transfers of the quantities of seeds and liquid within the system are controlled by an electronic control assembly in accordance with one or more selectable operational modes.

In a first embodiment, a system for coating seeds with a liquid may broadly comprise a seed bin assembly, a seed metering assembly, a liquid delivery assembly, a coating apparatus, and an electronic control assembly. The seed bin assembly may include a seed bin for containing the seeds, an outlet device for transferring a quantity of the seeds from the seed bin, and a seed weight sensor for determining a weight of the seed in the seed bin. The seed metering assembly may meter the transfer of the quantity of the seeds, including metering the quantity of the seeds as a plurality of subquantities. The liquid delivery assembly may include a reservoir for containing the liquid and may transfer a quantity of the liquid from the reservoir. The coating apparatus may receive the quantity of the seeds and the quantity of the liquid, and may include an atomizer for applying the quantity of the liquid to the quantity of the seeds, and a drum dryer for drying the coated seeds. The electronic control assembly may be configured to operate the seed bin assembly and the seed metering assembly in the following selectable modes. A first mode may involve determining an actual amount of the quantity of the seeds transferred from the seed bin based on a change in the weight of the seeds remaining in the seed bin after each transfer as indicated by the seed weight sensor, and adjusting operation of the seed metering assembly so that the actual amount of the quantity of the seeds matches an expected amount of the quantity of the seeds. A second mode may involve determining an actual amount of each subquantity of the seeds included in the quantity of seeds transferred from the seed bin based on a change in the weight of the seed remaining in the seed bin after each transfer as indicated by the first weight sensor, and adjusting operation of the seed metering assembly to account for a difference between the actual amount of the subquantity of the seeds and an expected amount of the subquantity of the seeds.

In a second embodiment, a system for coating seeds with a treatment liquid may broadly comprise a seed bin assembly, a seed metering assembly, as liquid delivery assembly, a coating apparatus, and an electronic control assembly. The seed bin assembly may include a seed bin for containing the seeds, an outlet device for transferring a quantity of the seeds from the seed bin, and a first weight sensor for determining a weight of the seeds in the seed bin. The seed metering assembly may meter the transfer of the quantity of the seeds. The liquid delivery assembly may include a reservoir for containing the liquid, as valve and a pump for transferring a quantity of the liquid from the reservoir, a flow metering assembly for metering the transfer of the quantity of the liquid, and a liquid weight sensor for determining the weight of the liquid in the reservoir. The coating apparatus may receive the quantity of the seeds and the quantity of the liquid, and including an atomizer for applying the quantity of the liquid to the quantity of the seeds, and a drum dryer for drying the coated seeds. The electronic control assembly may be configured to operate the liquid delivery assembly in the following selectable modes. A first mode may involve determining an actual amount of the quantity of the liquid transferred from the reservoir based on a change in the weight of the liquid remaining in the reservoir after each transfer as indicated by the liquid weight sensor, and adjusting operation of the flow metering assembly so that the actual amount of the quantity of the liquid matches an expected amount of the quantity of the liquid. A second mode may involve determining an actual flow rate of the transfer of the liquid from the reservoir, and adjusting operation of the liquid delivery assembly to account for a difference between the actual flow rate and an expected flow rate.

In a third embodiment, a system may provide both the selectable modes of the first embodiment and the selectable modes of the second embodiment for even greater redundancy and accuracy

Various implementations of the foregoing embodiments, may include any one or more of the following features. The seed bin assembly may include a plurality of adjacent seed bins. The outlet device may be a sliding gate configured to slide between a first position in which the quantity of the seeds flow from the seed bin assembly to the coating apparatus, and a second position in which the quantity of the seeds does not flow, and the electronic control assembly may be further configured to control movement of the sliding gate between the first position and the second position. With regard to the first embodiment, the seed metering assembly may include a rotatable seed wheel having a plurality of pockets, and each pocket may be configured to define the subquantity of the seeds. Adjusting operation of the seed metering assembly may include adjusting a speed of rotation of the rotatable seed wheel. The electronic control assembly may be further configured to operate the seed bin assembly and the seed metering assembly in a third mode which involves performing both the first and second modes. With regard to the second embodiment, adjusting operation of the liquid delivery assembly may include adjusting one or both of a position of the valve and a speed of the pump. The electronic control assembly may be further configured to operate the liquid delivery assembly in a third mode which involves performing both the first and the second modes. The electronic control assembly may be further configured to operate the liquid delivery assembly in a seventh mode which involves performing at least one of the first mode and the second mode and at least one of the third mode and fourth mode, or in an eighth mode which involves performing all of the first mode, the second mode, the third mode, and the fourth mode.

### BRIEF DESCRIPTION OF THE DRAWINGS

FIG. 1 is a high-level block diagram illustrating a seed treating system in accordance with the invention;

FIG. 2A is a schematic flow diagram illustrating three alternate modes of operation controlling the flow of seeds from a seed hopper;

FIG. 2B is a schematic flow diagram illustrating three alternate modes of operation controlling the flow of coating liquid from a liquid tank;

FIG. 3 is a perspective view of a preferred decreasing mass seed hopper assembly shown in conjunction with a seed treater;

FIG. 4 is a fragmentary side elevational view of the assembly depicted in FIG. 3, with the treater inlet illustrated in phantom;

FIG. 5 is a plan view of the seed hopper assembly;

FIG. 6 is a bottom view of the seed hopper assembly;

FIG. 7A is a fragmentary vertical sectional view of the seed hopper assembly, and illustrating in detail the construction of the upper turret assembly;

FIG. 7B is a fragmentary vertical sectional view illustrating in detail the outlet assembly of the seed hopper assembly;

FIG. 8 is an exploded perspective view of the seed hopper assembly;

FIG. 9 is an exploded perspective view of the upper turret assembly of the seed hopper assembly;

FIG. 10 is a fragmentary plan view of the seed hopper assembly, with the top wall of the turret assembly removed;

FIG. 11 is a perspective view of the turret assembly, illustrating the spring-biased seal plate at the outlet of the turret assembly;

FIG. 12 is a fragmentary perspective view illustrating the outlet assembly of the seed hopper assembly;

FIG. 13 is a perspective view of a single bin of the seed hopper assembly;

FIG. 14 is a fragmentary perspective view of an outlet of one of the bins of the seed hopper assembly;

FIG. 15 is an exploded perspective view of the outlet illustrated in FIG. 10.

FIG. 16 is a perspective view of a seed metering/seed treater assembly equipped with a rotatable seed metering wheel;

FIG. 17 is a perspective view of the seed metering wheel assembly and seed delivery chute forming a part of the seed treater apparatus;

FIG. 18 is a plan view of the apparatus illustrated in FIG. 17;

FIG. 19 is a vertical sectional view taken along the line 19-19 of FIG. 18;

FIG. 20 is a vertical sectional view taken along the line 20-20 of FIG. 18;

FIG. 21 is a top perspective view of the seed metering wheel assembly illustrated in FIG. 16;

FIG. 22 is a bottom perspective view of the seed metering wheel assembly illustrated in FIG. 21;

FIG. 23 is an exploded perspective view of the seed metering wheel assembly;

FIG. 24 is an exploded perspective view of the apparatus depicted in FIGS. 17-20;

FIG. 25 is a perspective view of an alternate seed metering assembly in the form of a rotatable metering gate;

FIG. 26 is a plan view of the metering gate assembly;

FIG. 27 is an end view of the metering gate assembly;

FIG. 28 is a side elevational view of the metering gate assembly;

FIG. 29 is a vertical sectional view taken along line 29-29 of FIG. 26;

FIG. 30 is a view taken along line 30-30 of FIG. 26;

FIG. 31 is an enlarged fragmentary view taken along line 31-31 of FIG. 26;

FIG. 32 is an enlarged fragmentary view depicting the drive cylinder for the metering gate assembly;

FIG. 33 is a perspective view of another seed metering wheel design;

FIG. 34 is a plan view of the seed metering wheel of FIG. 33;

FIG. 35 is an upper, perspective, exploded view depicting the components of the seed metering wheel of FIG. 33;

FIG. 36 is a lower, perspective, exploded view depicting the components of the seed metering wheel of FIG. 33;

FIG. 37 is a vertical sectional view taken along the line 37-37 of FIG. 34;

FIG. 38 is a vertical sectional view taken along the line 38-38 of FIG. 34;

FIG. 3916 is a vertical sectional view taken along the line 39-39 of FIG. 34; and

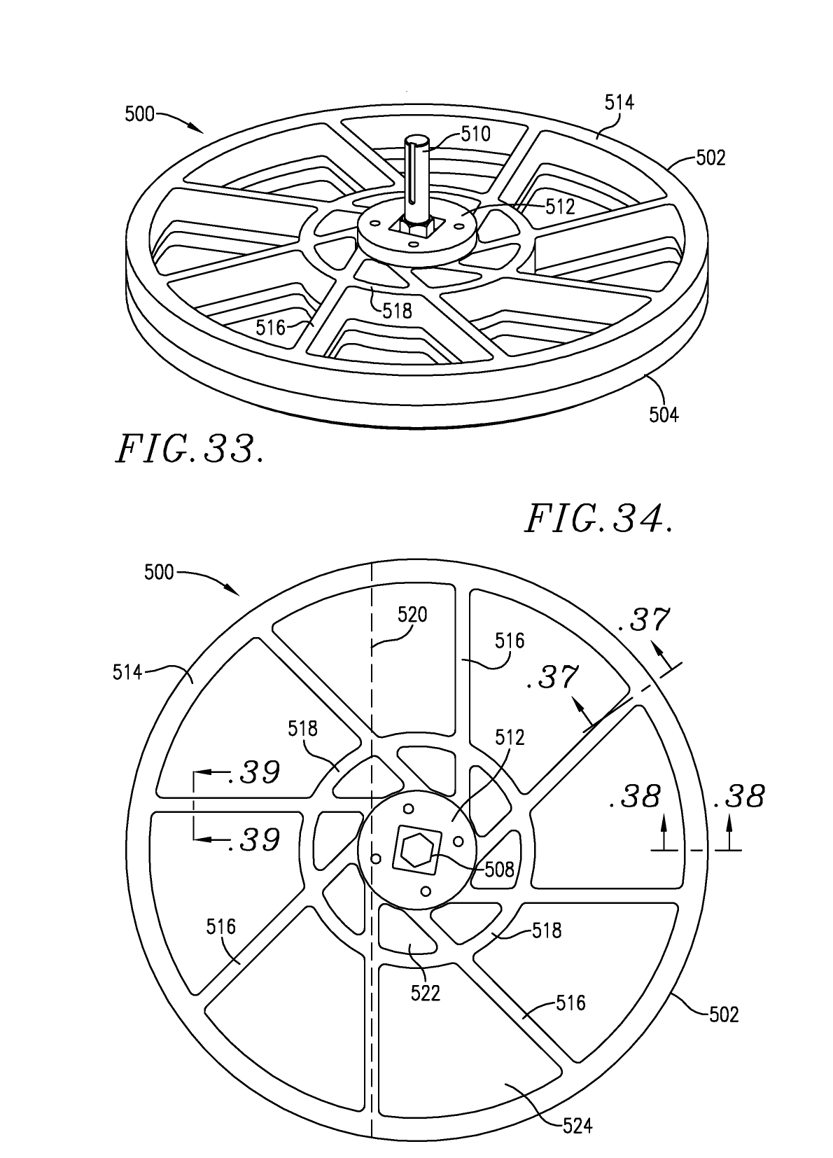

FIG. 40 is a top view illustrating the seed metering wheel of FIG. 33 within the overall seed metering assembly;

FIG. 41 is a front perspective view of a liquid treatment delivery assembly in the form of a pump stand;

FIG. 42 is a rear perspective view of the pump stand depicted in FIG. 41;

FIG. 43 is a schematic flow diagram illustrating the preferred electronic processor control of the pump stand, during the flow rate metering mode and combined modes of operation of the liquid delivery coating assembly;

FIG. 44 is a perspective view of a single batch seed hopper in conjunction with a seed treater;

FIG. 45 is a perspective view, with parts removed, of the seed hopper illustrated in FIG. 44;

FIG. 46 is a front perspective view of another pump stand useful in carrying out the invention and equipped with a conical tank;

FIG. 47 is a rear perspective view of the pump stand illustrated in FIG. 46;

FIG. 48 is a front perspective view of another pump stand useful in carrying out the invention and equipped with a tote or keg tank; and

FIG. 49 is a rear perspective view of the pump stand illustrated in FIG. 48.

### DETAILED DESCRIPTION OF THE PREFERRED EMBODIMENTS

The present invention provides methods and apparatus for improved, highly accurate control of the amount of seeds which are delivered from one or more seed bins, and coating liquid from a liquid tank or other reservoir, to a downstream treater/coater device.

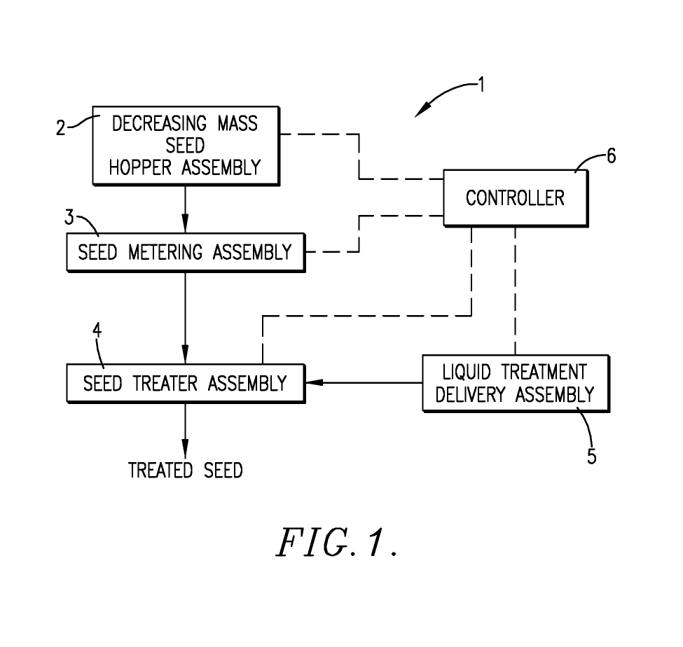

Generally speaking, the invention provides a system 1 including a series of interconnected, assemblies providing high-redundancy, very accurate treatment of seeds with various treating liquids. As illustrated in FIG. 1, the system 1 of the invention broadly includes a decreasing mass (loss-in-weight) hopper or bin assembly 2, a seed metering assembly 3, a seed treater assembly 4, and a liquid treatment delivery assembly 5. The assemblies 2-5 are operably connected with and controlled by control assembly 6, typically in the form of one or more programmable logic controller (PLCs).

The assembly 2 includes appropriate weighing devices to continuously determine the weight of seeds within the bin assembly, typically in the form of one or more load cells supporting the seed bin(s). This allows continuous determination over time of the loss of weight in the bin(s). The seed metering assembly 3 is preferably in the form of a rotatable seed wheel assembly or a rotary gate assembly, which receives seed from the weigh bin assembly 2. The seed treater assembly 4 is itself conventional, and includes an inlet for a quantity of seeds delivered from the seed metering assembly 3, and is equipped with a liquid treatment applicator or atomizer and a rotatable drum dryer. The liquid treatment delivery assembly 5 is also coupled with the seed treater assembly 4 for delivering a quantity of treatment liquid to the applicator of the assembly 4, and has a liquid tank or other reservoir, a weigh scale, and selectively operable pump and valve structures for delivery of liquid from the tank.

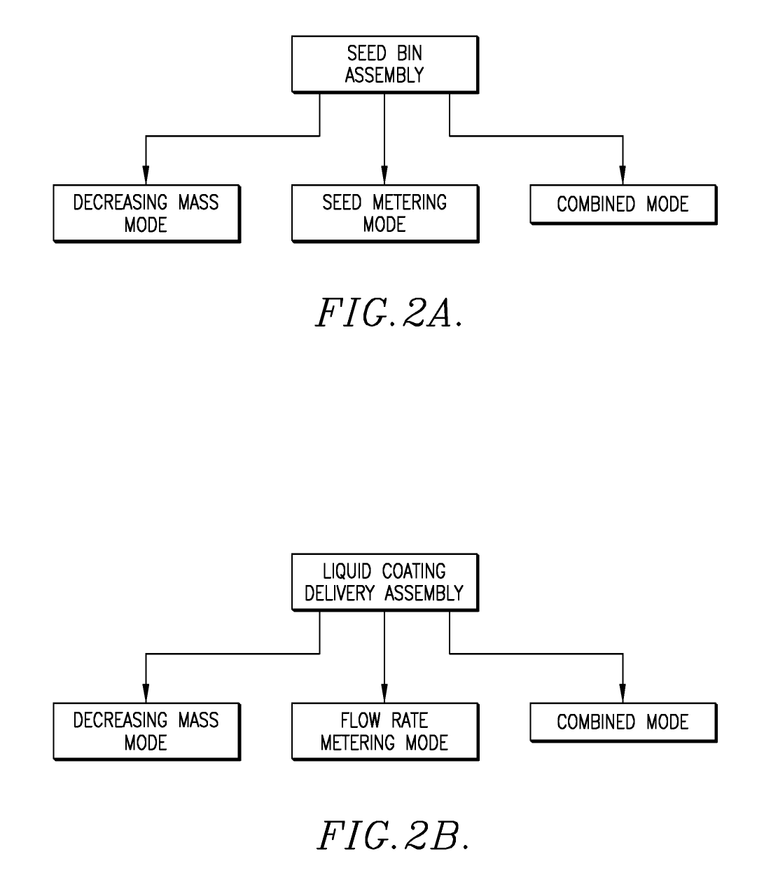

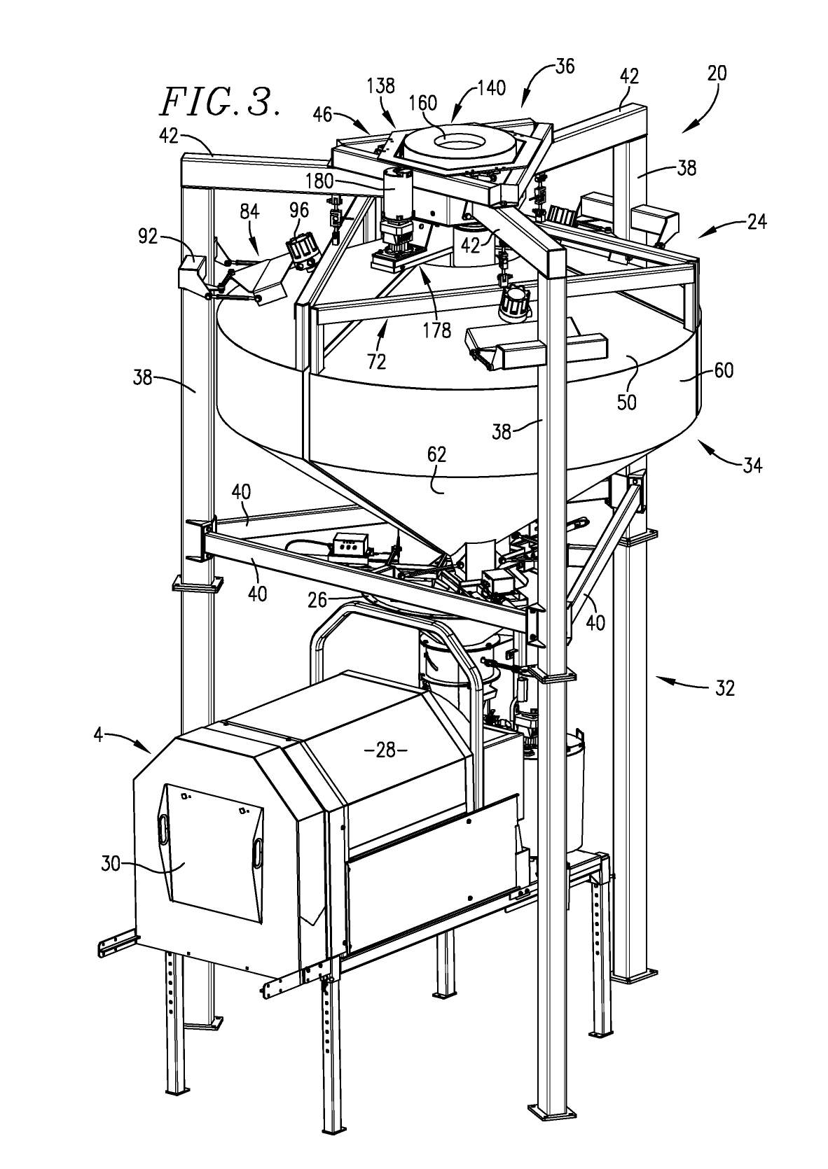

FIGS. 2A and 2B illustrate that the seed bin and liquid coating delivery assemblies can be alternately operated in separate modes, depending upon operator preference and conditions of the equipment. These are, respectively, decreasing mass modes for the seed and liquid, seed metering mode, flow rate metering mode, and combined modes. In the latter case, the accuracy of seed coating is enhanced owing to sequential re-calibration of the outputs from the seed bin assembly and liquid coating delivery assembly, during the course of seed treating.

In order to facilitate an understanding of the invention, and specifically the illustrated system 1, the individual subassemblies 2-5 and controller 6 will be separately described.

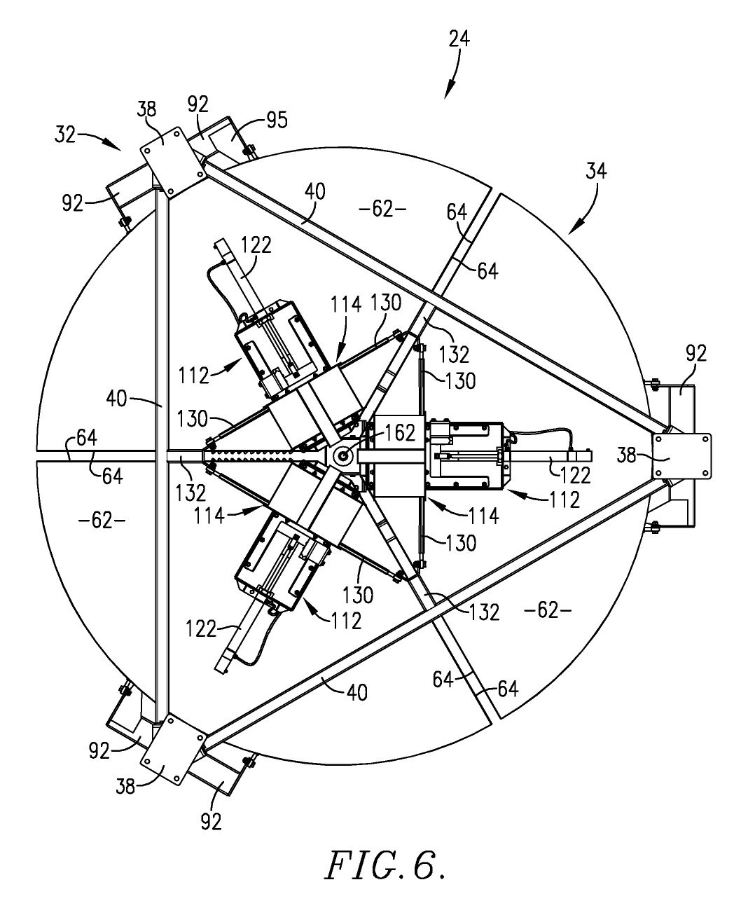

Turning now to FIGS. 3-15, a seed treater system 20 is illustrated in FIG. 3 and broadly includes a seed treater assembly 4 and a multiple-bin decreasing mass seed hopper/handling assembly 24 situated above the assembly 4. The treater system 20 is designed to coat agricultural seeds with any one of a number of selected, treating agents, and to deliver the treated seeds in known quantities to a conveyor or other exit device (not shown).

The seed treating assembly 4 is itself conventional and includes an upper, open-top inlet 26, a treating chamber 28 and an outlet chute 30. A variety of commercially available treating units may be used in the overall seed treater system 20. Preferably, the assembly 4 is one of the treaters sold by USC, LLC of Sabetha, Kans.

### Hopper Assembly 2

The preferred seed handling assembly 24 generally includes frame structure 32, a plurality (here three) of juxtaposed, identical seed bins 34, and a rotary turret assembly 36 designed to supply incoming seed to each of the bins 34. As illustrated, the seed handling assembly 24 is operable to deliver seed to the inlet 26 of treating assembly 4.

The frame structure 32 includes three equidistantly spaced, upright, sectionalized support legs 38 with intermediate cross-braces 40 extending between the legs 38. An inwardly extending support beam 42 is secured to the upper end of each of the legs 38 and has an innermost apertured connection plate 44. A triangular turret frame 46 having apex-mounted, apertured connection flanges 47 is positioned atop and secured to the midpoints of the support beams 42 by means of threaded connectors 48 extending through the flanges 47 and beams 42.

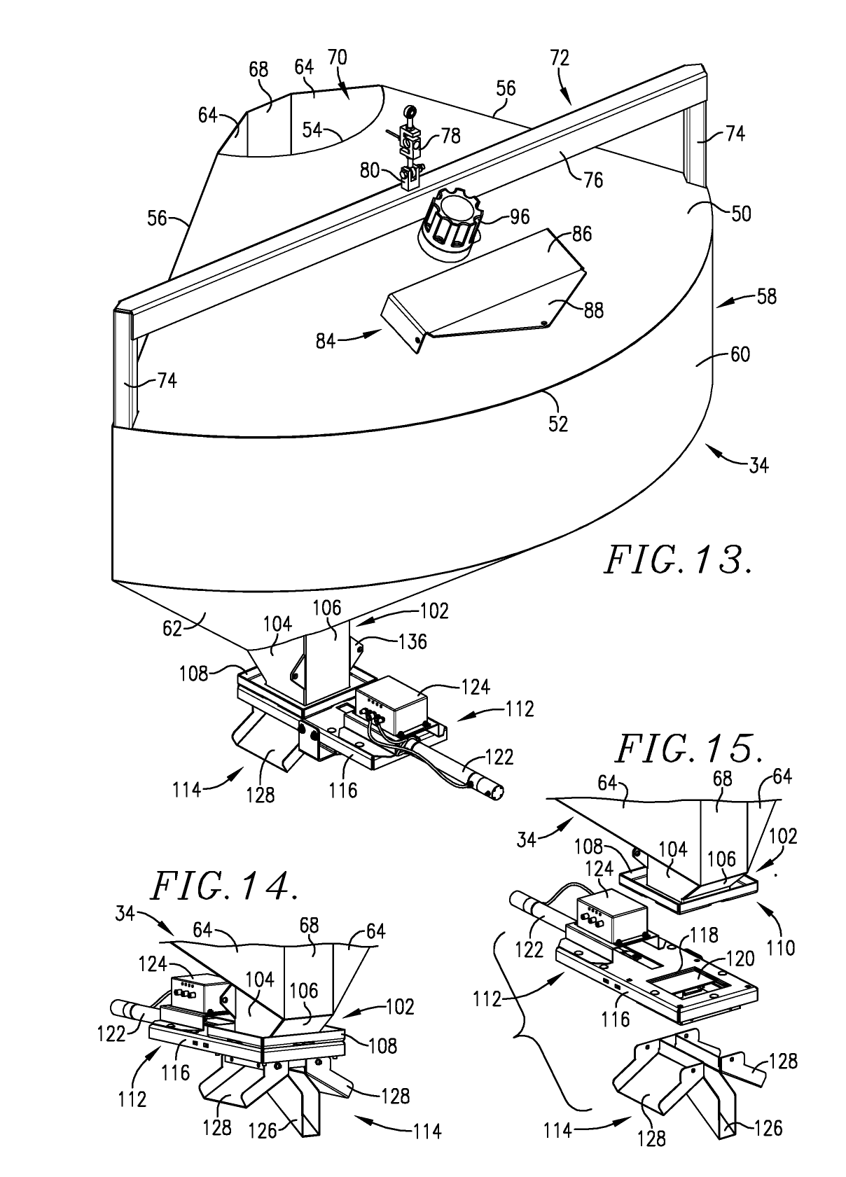

Each bin 34 (see FIG. 13) has a top wall 50, with an outermost arcuate margin 52, an inner margin 54, and a pair of inwardly extending, converging side margins 56. Each top wall 50 is a truncated conical sector. Accordingly, each top wall 50 in plan configuration approximates a sector of a circle, and particularly a 120 section. In preferred forms, the top wall 50 is not a complete sector, but is truncated by the inner margin 54. The bin 34 also has depending sidewall structure 58 including an arcuate upper section 60 depending from arcuate margin 52, and an inwardly tapered arcuate lower section 62 extending from the lower margin of the section 60. Each section 62 is also a conical sector, so that in a bottom view the sections 62 are in the shape of an approximate sector of a circle.

A pair of upright, substantially planar sidewalls 64 depend from the side margins 56. The inboard ends of the sidewalls 64 are interconnected by means of a planar segment 68. The top wall 50 and sidewall structure 58 are interconnected in order to define a seed holding interior space. The inner margin 54 of top wall 50 and the upper margins of the sidewalls 64 and segment 68 cooperatively define a seed inlet 70.

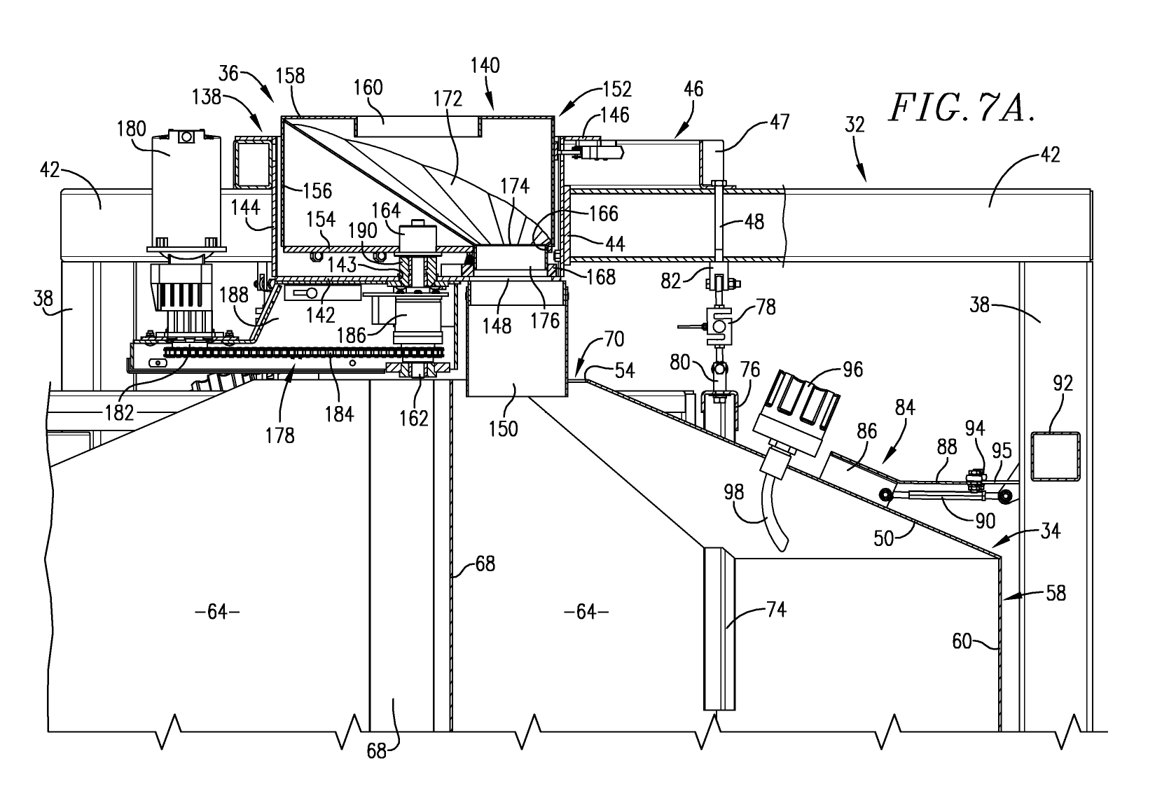

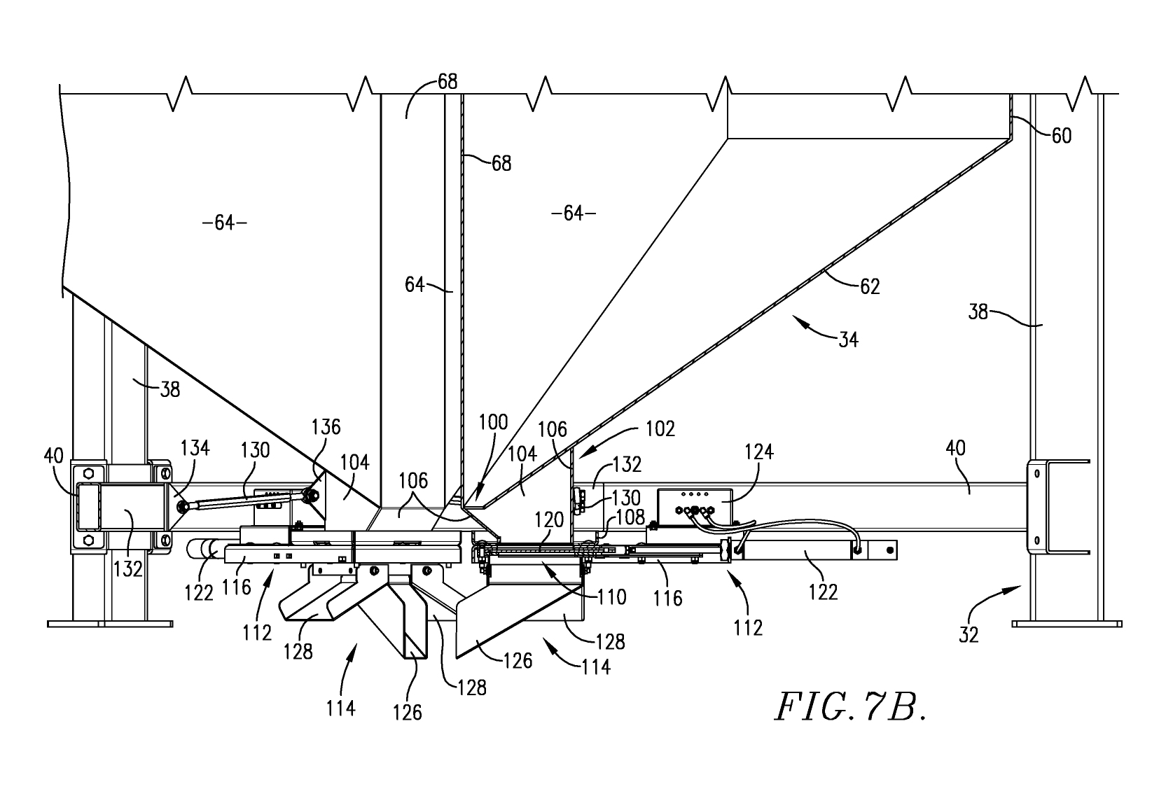

Each bin 34 is equipped with a generally U-shaped support bail 72 having upwardly extending legs 74 at the juncture between the margins 52 and 56, with a cross-rail 76 secured to the upper ends of the legs 74. A load cell 78 is secured to the midpoint of cross-rail 76 by means of a lower clevis 80. The upper end of each load cell 78 is secured by means of an upper clevis 82 threaded to the lower end of the adjacent connector 48, so as to suspend each bin 34 from the associated support beam 42. In order to provide more precise weight control, a plurality of load cells 78 may be used in lieu of a single cell. A stabilizing assembly 84 is centrally secured to the upper surface of top wall 50 and includes a U-shaped body 86 and an upwardly inclined, apertured, generally triangular connector plate 88. A pair of adjustable links 90 are secured to the sidewalls of body 86 with the remote ends thereof attached to stabilizer beams 92 affixed to the adjacent support leg 38 of frame structure 32. An adjustable link 94 is connected between the plate 88 and a flange 95 forming a part of one of the beams 92. A conventional bin full sensor 96 is attached to top wall 50 and has an inwardly extending probe 98 (FIG. 7A).

Referring now to FIGS. 7B and 13-15, the lower outlet end of each bin 34 is depicted. Specifically, the tapered, lower arcuate sidewall section 62 has a lower opening 100. A delivery chute 102 comprising sidewalls 104 and end walls 106 depends from the lower end of the bin and has a surrounding box-like mounting flange 108. The opening 100 and delivery chute 102 thus define a lower seed bin outlet 110.

In order to selectively regulate the flow of seed from outlet 110, the bin 34 is equipped with a slide gate assembly 112 and a multiple-chute assembly 114. The slide gate assembly 112 includes a primary frame 116 with a through-opening 118. A selectively shiftable slide gate 120 is supported by the frame 116 and is shiftable in a fore-and-aft fashion between a fully closed position blocking flow of seed through the opening 118, and an infinite number of partially open intermediate positions and a full-open position. Each slide gate assembly 112 has a sensor for detecting whether the slide gate 120 is in a closed or open position. Movement of the slide gate 120 is effected by means of a double-acting pneumatic piston and cylinder assembly 122 equipped with an open slide gate position sensor. A control valve 124 is also supported on the primary frame 116 and is operatively coupled with the pneumatic cylinder and an electronic controller (not shown) which controls the operation of the assembly 122. As illustrated in FIGS. 13 and 14, the primary frame 116 is designed to mate with the flange 108, such that the lower seed outlet opening 110 is in registry with through-opening 118. In the context of the present invention, the slide gate assembly 112 is in the full-closed position when the bin is not delivering seed, and is in the full-open position when seed is being delivered therefrom.

The chute assembly 114 is secured to the underside of primary frame 116 and comprises a relatively narrow central chute 126 and a pair of oppositely outwardly extending wider chutes 128. Seed delivered through opening 118 is thus separated into three individual streams by the chutes 126, 128. However, the use of multiple chutes is not essential in carrying out the present invention, i.e., the seed from each bin 34 can fall directly from the slide gate assembly 112 into subassembly B or C.

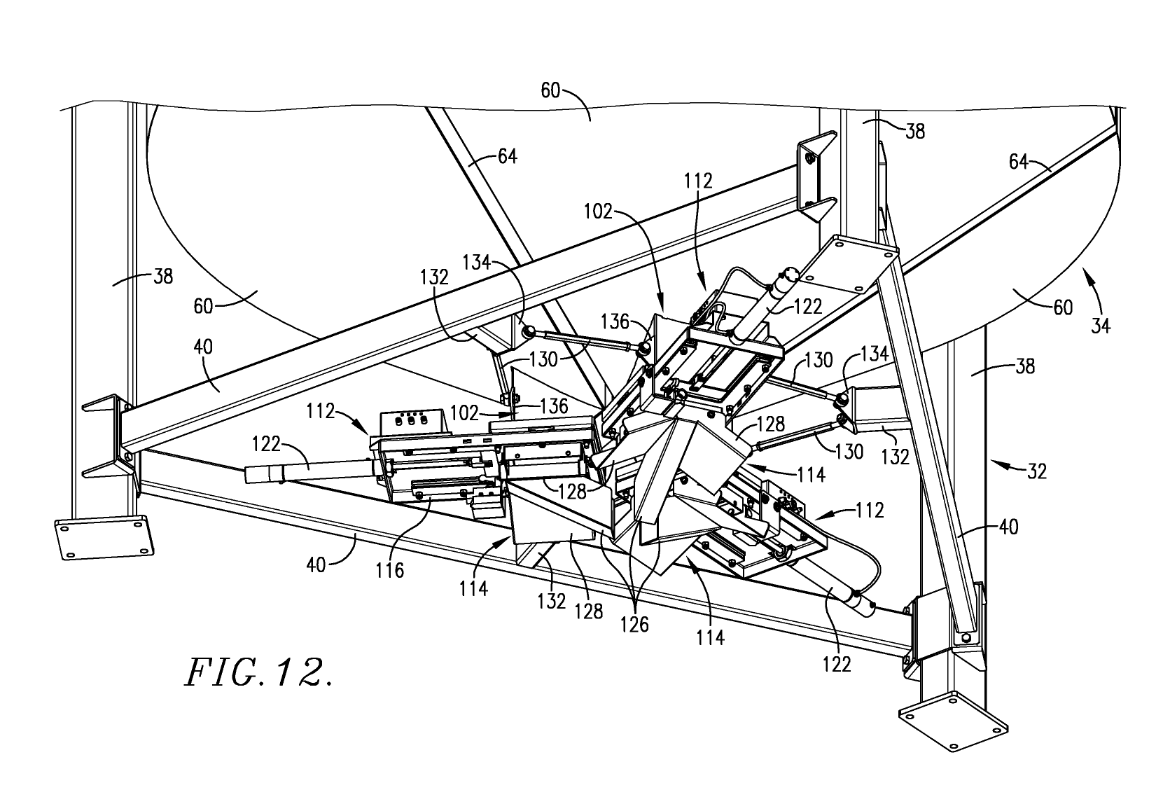

In order to stabilize the lower end of the bin 34, a pair of oppositely outwardly extending adjustable links 130 are connected to the chute 102 and the adjacent cross-braces 40. To this end, the cross-braces 40 are provided with central, inwardly extending stubs 132, and the links 130 are interconnected between flanges 134 on the stubs 132, and flanges 136 on the chute 102 (see FIGS. 12-13).

The turret assembly 36 is best illustrated in FIGS. 7A and 9. The assembly 36 generally has a stationary turret mount 138 and a rotary turret 140 within the mount. The mount 138 is hexagonal in configuration, having a bottom wall 142 equipped with a central bearing opening 143, six interconnected, upstanding sidewalk 144, and an uppermost, circumscribing mounting lip 146. The bottom wall 142 has three equidistantly spaced through-openings 148. The sidewalls 144 support three equidistantly spaced location sensors 149 which are designed to sense the position of turret 140. Three flexible tubular guides 150 are secured to the underside of bottom wall 142 in registry with the corresponding openings 148. The turret mount 138 is supported on turret frame 46 with the lip 146 overlying the bars making up frame 46 (FIGS. 5 and 7A).

The turret 140 comprises a cylindrical housing 152 including a bottom wall 154, upstanding, circular sidewall 156, and a top wall 158 having, a central inlet opening 160. A sensor element 155 is secured to the outer surface of sidewall 156 and is oriented to be sensed by the location sensors 149. The housing 152 is equipped with a central drive shaft 162 secured by a coupler 164 and extending below bottom wall 154. The bottom wall 154 also has an offset outlet opening 166, with an apertured seal plate 168 positioned below the opening 166 and in registry therewith. The seal plate 168 is secured to bottom wall 154 by means of connecting bolts 170 passing through the plate 168 and threaded into bottom wall 154, with conical springs disposed about each bolt 170. An obliquely oriented chute 172 is located within housing 152 and has a lower opening 174 with a short, downwardly extending, tubular transition 176.

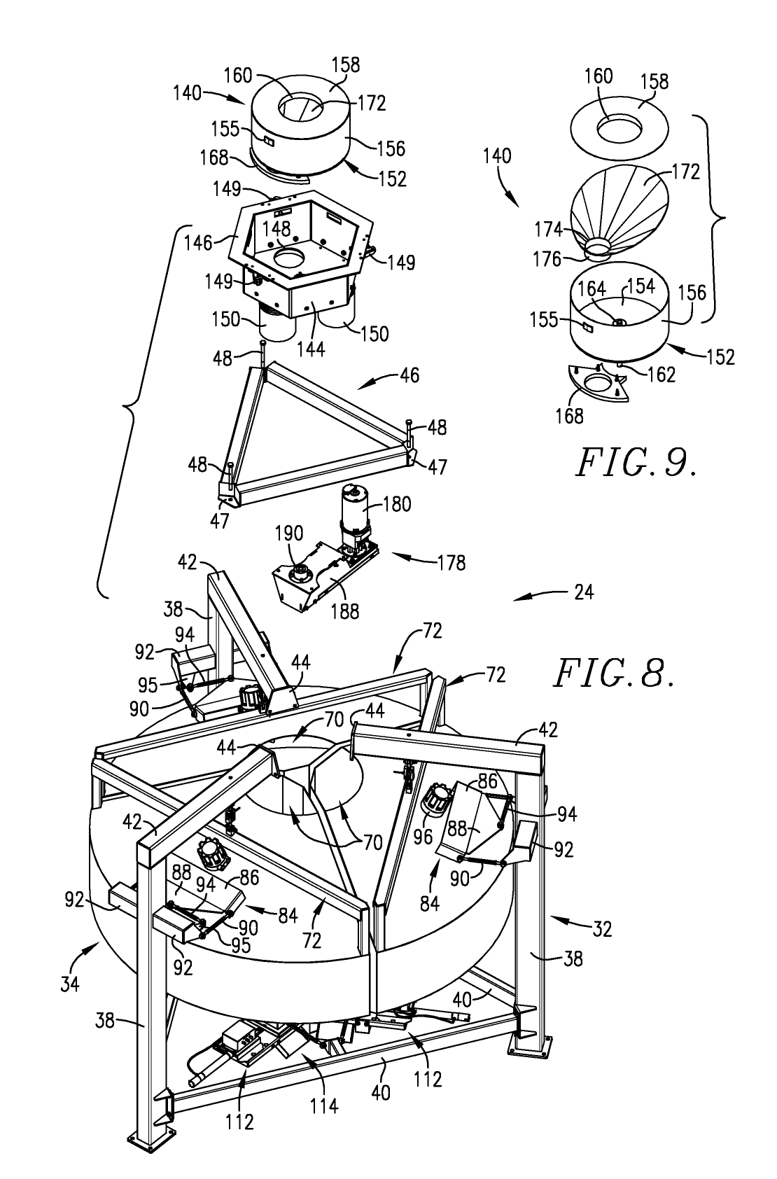

A drive unit 178 (FIGS. 7A and 8) is located beneath the turret mount 138 and includes an electric drive motor 180 having an output sprocket 182 and a drive chain 184 trained about the sprocket 182. The chain 184 is also trained about a clutch assembly 185 receiving shaft 162. The sprocket 182, chain 184, and clutch assembly 186 are located within the surrounding housing 188. The latter has an upstanding, tubular bearing assembly 190.

As best seen in FIG. 7A, the turret 140 is received within the turret mount 138, with the drive shaft 162 extending through the bearing assembly 190 and clutch assembly 186, such that the turret 140 is rotatable relative to the turret mount 138. Hence, operation of motor 180 serves to rotate turret 140, as will be described in detail below.

In practice, three of the bins 34 are supported in juxtaposed relationship by the frame structure 32, so that the grouped bins present a substantially circular configuration in plan. Each such bin is supported by one or more load cells 78, the latter interconnected between an upper support beam 42 and an underlying bail 72. In this orientation, the sidewalk 64 of the bins 34 are in close, parallel adjacency, and the flexible tubular guides 150 extend into the corresponding bin seed inlets 70, and the tapered sidewall sections 62 converge towards a common lower apex. The three chute assemblies 114, being closely adjacent and near the bottom of the respective bins, are sized to be received within the inlet 26 of seed treater system 20. The stabilizing couplers 90, 94, and 130 serve to maintain the position of the suspended bins 34 within the frame structure 32.

Control of the seed handling assembly 24 is accomplished through one or more programmable electronic controllers, including but not limited to controller 6, which are suitably connected with the aforementioned sensors, load cells 78, control valves 124, and the drive motor 180 and clutch assembly 186 forming a part of the turret drive unit 178. The controller(s) are appropriately programmed to carry out the operation of assembly 24, as described below.

### Operation

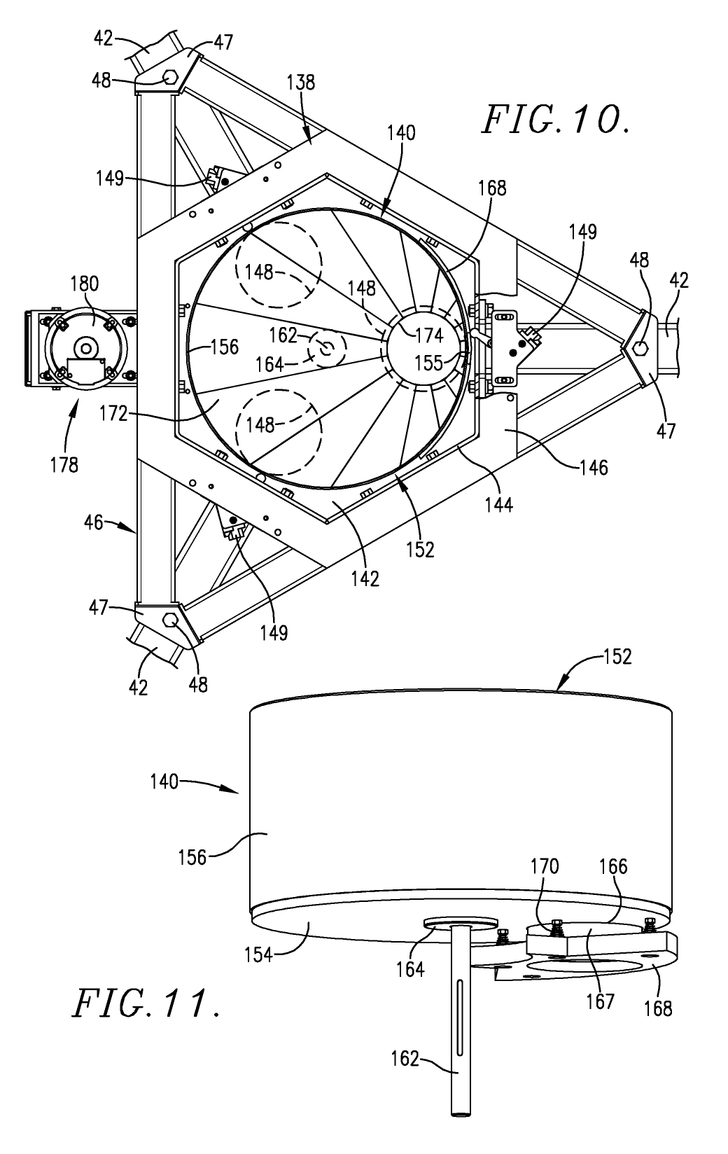

In the operation of the decreasing mass seed hopper/bin assembly 24, incoming seed is delivered through the turret central inlet opening 160 by any convenient means. Typically, this is effected by an inclined conveyor leading from a supply of seed to the opening 160. The incoming seed is sequentially diverted to each of the bins 34 by appropriate positioning of the rotary turret 140 within turret mount 138, so that the lower opening 174, the opening of seal plate 168, and transition 176 of the chute 172 come into registry with one of the through-openings 148 of bottom wall 142. This is illustrated in FIGS. 7A and 10 where the opening 174 and transition 176 are in registry with one of the openings 148, with the other two openings circumferentially spaced from the one opening 148. Seed is delivered to the associated bin 34 by passage along chute 172, through opening 174 and transition 176, and ultimately through the guide 150 into the interior of the bin.

As seed accumulates within one of the bin 34, the weight of the bin is monitored by the associated load cell(s) 78 and bin full sensor 96. When the one bin is filled to the desired degree, the turret 140 is shifted or indexed via turret drive unit 178 so that the lower opening 174 and transition 176 of turret 140 come into registry with the next adjacent opening 148 and guide 150, and the process is repeated. During such movement, the spring-biased seal plate 168 engages the upper surface of bottom wall 142. Precise positioning of the turret 140 is obtained by means of the position sensors 149 and sensor element 155. In this fashion, the turret 140 successively diverts seed to and fills the three bins 34.

Simultaneously with this stepwise filling of the bins 34, seed is delivered through the lower bin outlets 110, slide gate assemblies 112, and multiple-chute assemblies 114; however, seed is not added to a bin 34 while seed is being delivered therefrom. Flow of seed is controlled by the respective positions of the slide gate assemblies 112. Thus, the seed travels from the seed bins 34, through delivery chutes 102 and through-openings 118, as governed by positions of the slide gates 120.

The bins 34 are sequentially filled and emptied using known decreasing mass techniques so that a substantially even supply of seed is delivered to the underlying seed metering assembly 3. As explained, more fully below, the decreasing mass data derived from assembly 2 is used as an input to controller 6.

Although the foregoing description refers to the use of a three-bin apparatus, which is commercialized by USC, LLC of Sabetha, Kans. under the trademark Tri-Flo®, the invention is not so limited. That is to say, a single bin decreasing mass seed hopper assembly could be employed, so long as it is equipped with an appropriate outlet valve or gate and weighing devices permitting calculation of loss in weight during operation. Such an option is described with reference to FIGS. 44 and 45.

### Assemblies 2/3—Seed Metering/Seed Treater Assemblies

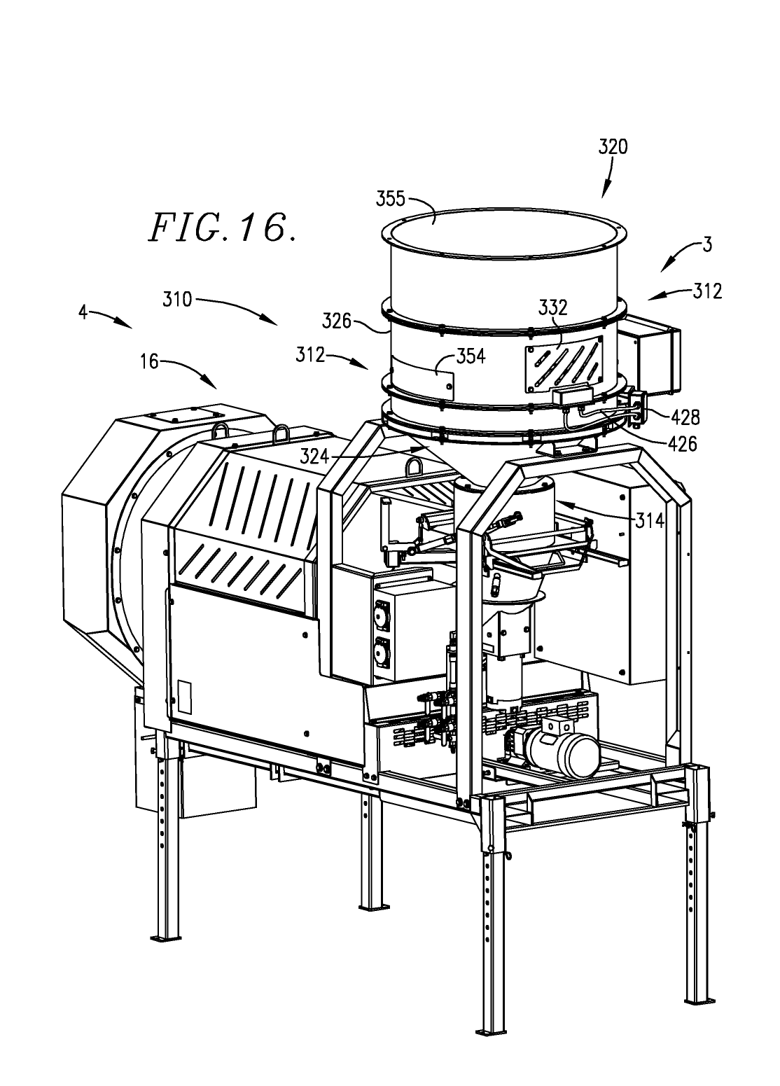

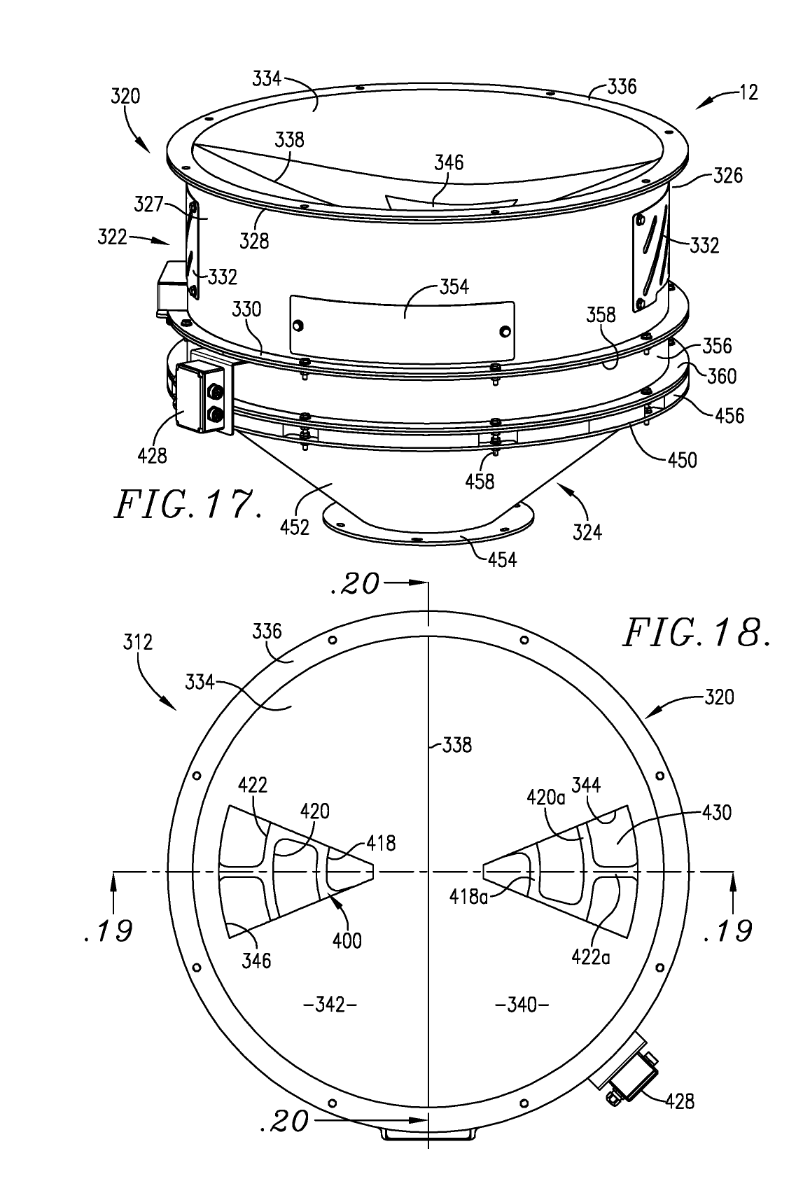

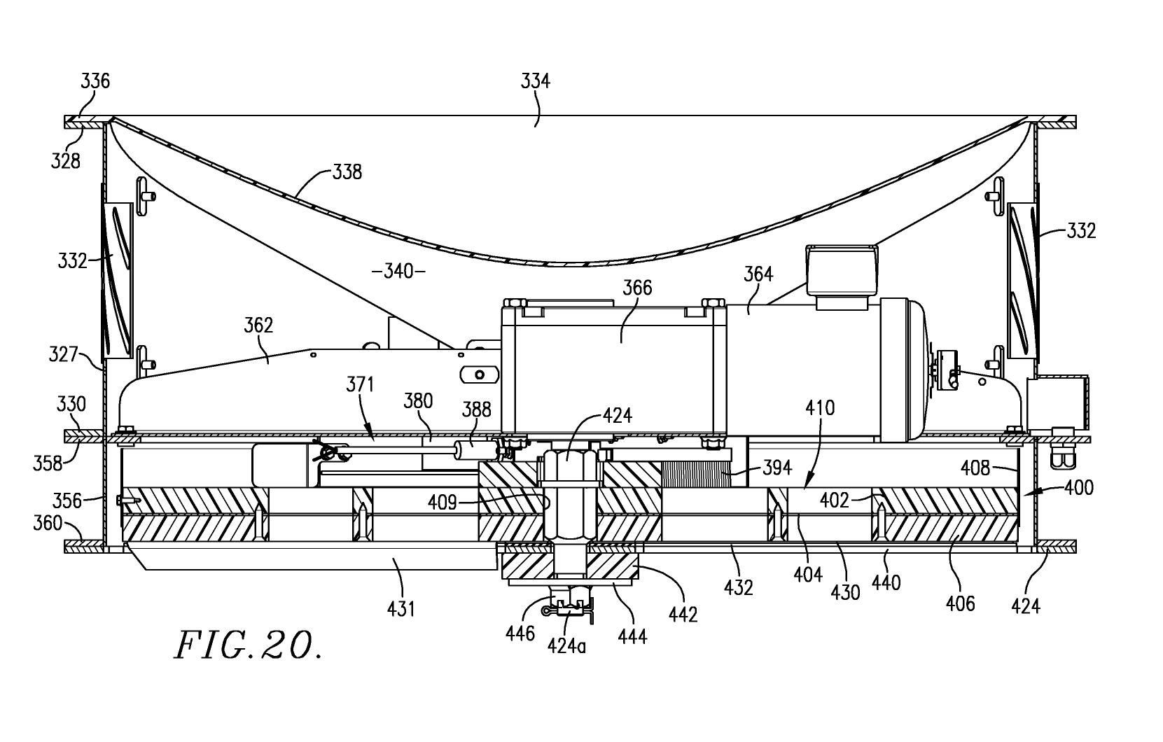

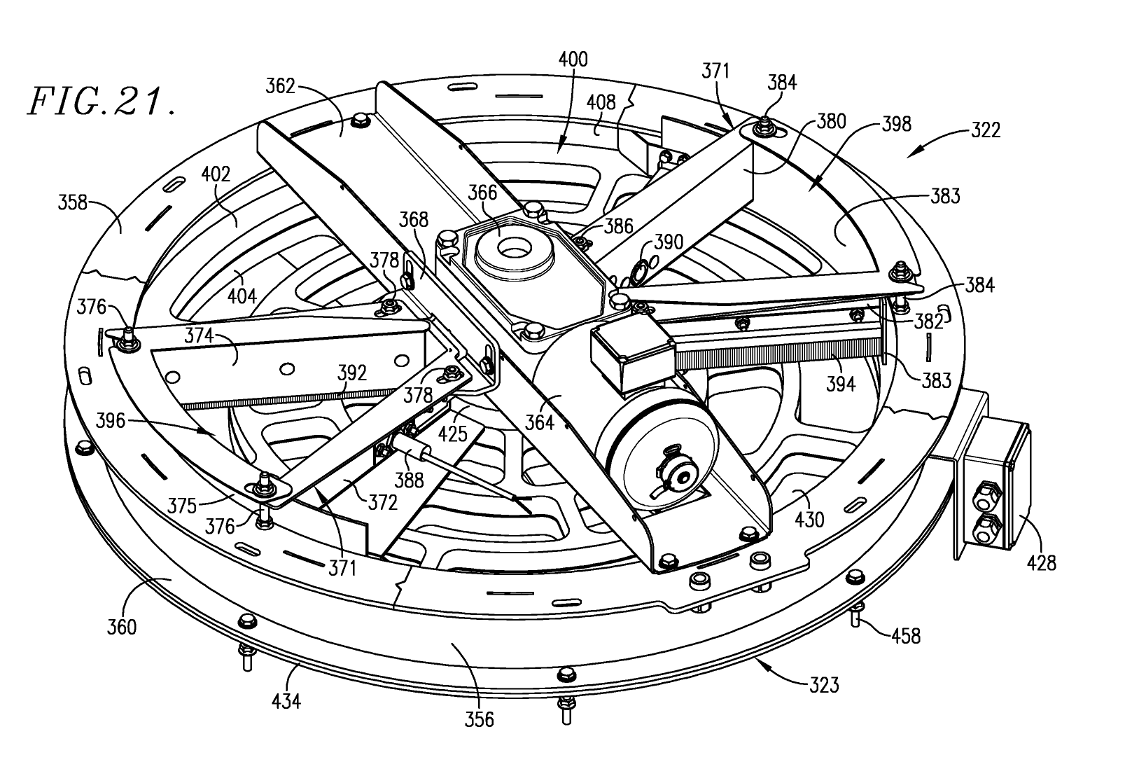

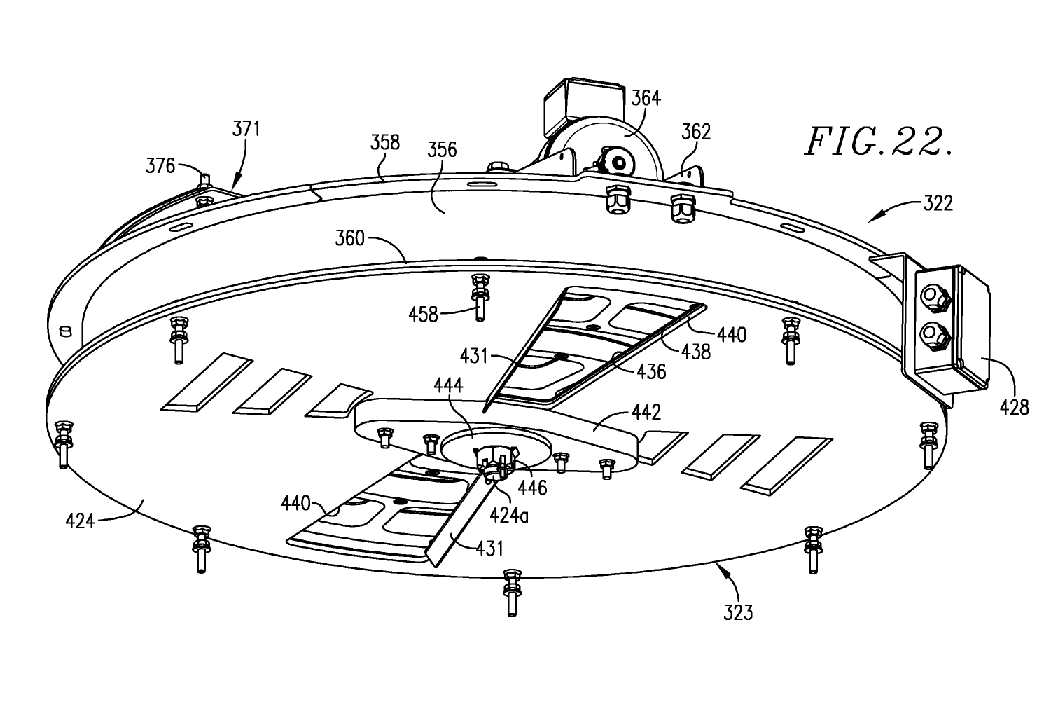

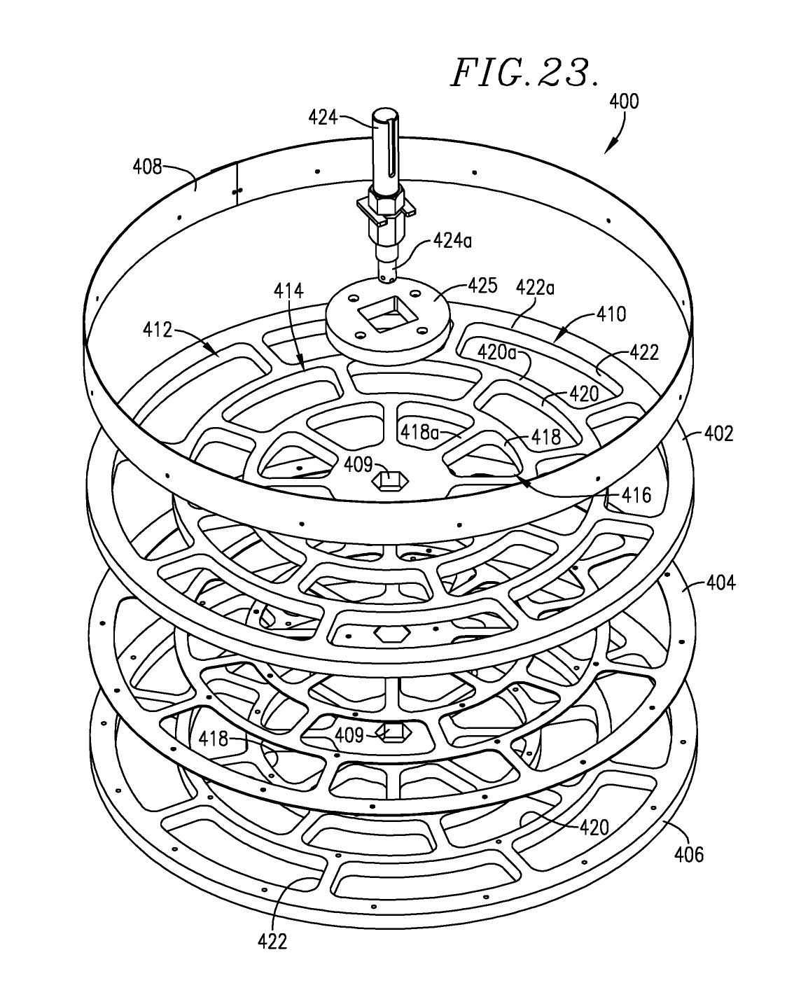

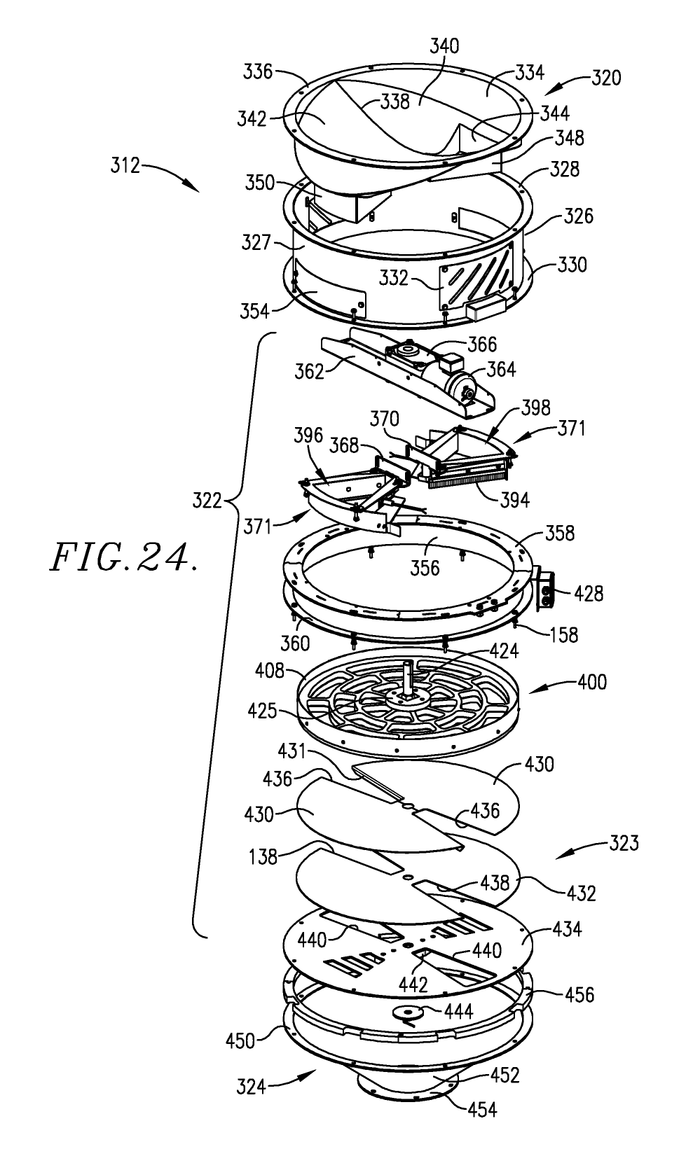

Referring now to the FIGS. 16-24, a combination device 310 is depicted, broadly comprising a seed metering assembly 3 interconnected with a seed treater assembly 4. The illustrated seed treater assembly 4 includes a metering seed wheel assembly 312, which directs incoming seed from the decreasing mass seed hopper assembly 2 into an atomizer 314 where the seeds are coated with chemical(s). The preferred atomizer is described in U.S. Pat. Nos. 6,551,402 and 6,783,082, incorporated by reference herein. The coated seeds are then dried within a downstream rotating drum dryer 316, and the finished seeds are delivered by way of an outlet for storage or use.

The seed metering wheel assembly 312 broadly includes an uppermost hopper assembly 320, an intermediate metering assembly 322, a lower plate assembly 323, and a lowermost delivery chute 324, which is secured to the inlet end of atomizer 314.

The hopper assembly 320 includes a housing 326 having an upright tubular sidewall 327, circular upper and lower connection flanges 328 and 336, a pair of opposed vents 332, and a series of removable access plates 354. A unitary seed-receiving hopper 34 having a connection flange 336 is positioned within the confines of housing 326, such that the flanges 336 and 330 mate and are connected via fasteners (not shown). The hopper 34 has an arcuate center line apex 338 with identical, downwardly extending, arcuate wall sections 340 and 342 each equipped with an identical, generally triangularly-shaped seed outlet opening 344 or 346; the latter have downwardly extending, defining wall structures 348 or 350. If desired, a tubular extension 355 (FIG. 16) may be attached to the upper end of housing 326 in order to increase the effective volume of the hopper assembly 320.

The seed metering assembly 322 is positioned below hopper assembly 320 and includes a stationary, tubular housing 356 with upper and lower connection flanges 358 and 360. The upper flange 358 of housing 356 mates with lower flange 330 of assembly 320, with appropriate fasteners serving to connect the flanges. The housing 356 supports a stationary channel 362, which in turn supports a variable frequency device-controlled electrical drive motor 364 and gear box 366. The channel 362 also supports a pair of outboard brackets 368 and 370 at the central region thereof. A pair of identical, generally triangular weldments 371 are respectively connected to the brackets 368 and 370 and extend outwardly and are supported by the housing 356. The weldments 371 each include a pair of diverging box sidewalls 372, 374 and 380, 382, as well as an outboard spacer 375 or 383, and fasteners 376, 378 or 384, 386. Proximity seed sensors 388 and 390 are respectively connected with box sidewalls 372 and 380. A lowermost, radially extending brush 392 is secured to sidewall 374, and an identical brush 394 is secured to sidewall 382. It will be observed that the weldments 371 each define a substantially triangular through-opening 396 or 398, and are respectively in registry with the seed outlet openings 344 and 346 of hopper assembly 320. It will thus be appreciated that the openings 396, 398 are seed entrance openings for the metering assembly 322.

The overall metering assembly 322 also includes an axially rotatable metering wheel 400, which is situated within the confines of housing 356. The wheel 400 is of composite design (see FIG. 23) and has a series of interconnected, apertured plates, namely an upper synthetic resin wheel plate 402, an intermediate stainless steel reinforcing plate 404, and a lower synthetic resin plate 406. A circumscribing, upwardly extending seed retaining ring 408 surrounds the apertured plates and extends above the upper surface of plate 402. The interconnected plates 402-406 have a central, hexagonal drive opening 409 and a series of seed metering openings 410 therethrough. In detail, the openings 410 are arranged in a total of three circular arrays 412, 414, and 416. The inner array 416 has a plurality of identical, truncated triangular through openings 418; the intermediate array 414 has a plurality of identical, elongated, arcuate openings 420, which are in staggered relationship relative to the openings 418. Finally, the outer array 412 has another series of identical, elongated arcuate openings 422, which are staggered relative to the openings 420 of the intermediate array. It will further be observed that the openings 418, 420, and 422 are each defined by circumscribing rib sections 418a, 420a, and 422a.

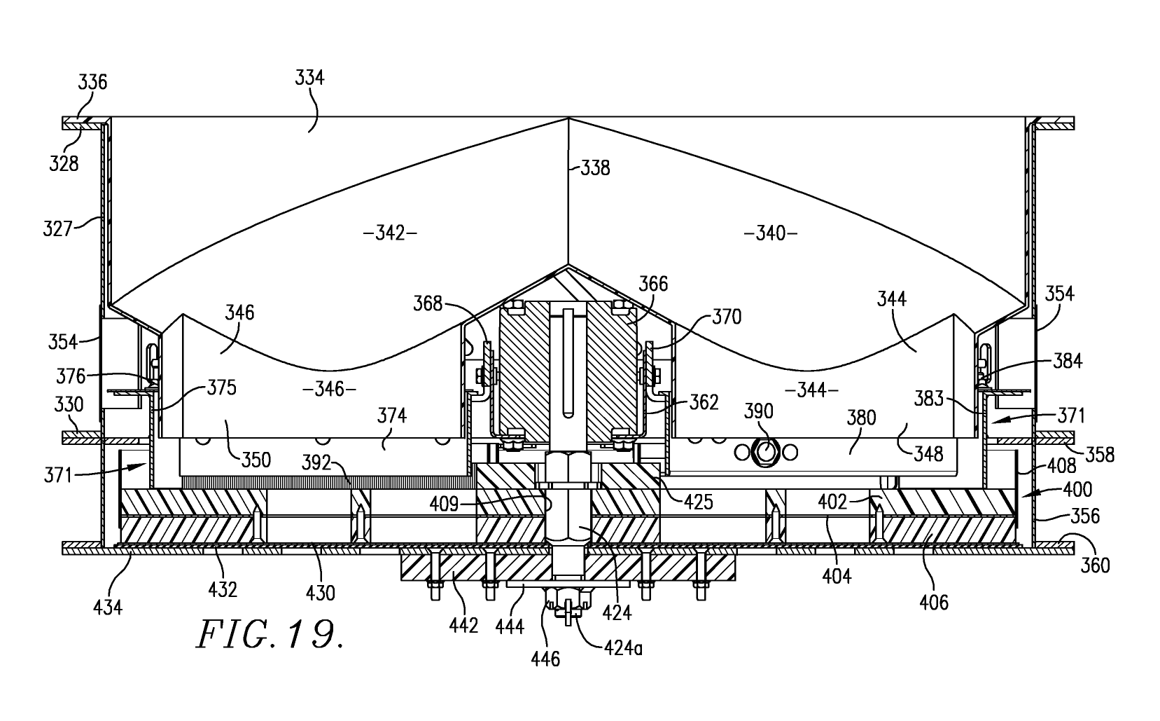

The metering wheel 400 is rotated in a clockwise direction, as viewed in FIG. 19, by means of the motor 364 and gear box 366. The box 366 has an elongated, hexagonal, vertically extending, rotatable drive shaft 424 with a lowermost, downwardly extending threaded shank 424a extending below the wheel 400. The shaft 424 and hub 425 serve to rotate the wheel 400, with the shaft 424 received within the central drive opening 409. The operation of motor 364 is controlled by means of conventional wiring including electrical leads 426 and junction box 428 connected to control assembly 6.

Plate assembly 323 is stationary and includes an upper metallic wear plate 430 which engages the lower surface of wheel 400, a synthetic resin foam support pad 432, and a lowermost metallic floor plate 434. The plates 430 and 432 have identical, opposed, outwardly diverging slots 436 and 438, whereas plate 434 has similarly configured through openings 440. The wear plate 430 has a pair of downwardly extending flanges 431 adjacent the edges of openings 436, which direct seed downwardly as the seed exits the assembly 323. The assembly 323 is mounted on shank 424a, and an elongated bearing plate 442, washer 444, and nut 446 are used to mount the assembly 323.

The delivery chute 324 is generally frustoconical and has an uppermost connection flange 450, a tapered hollow body section 452 and a lowermost connection flange 454. The flange 450 is connected to the underside of the plate assembly 323 (with optional use of a spacer ring 456) by means of elongated connectors 458.

As is evident from the foregoing description, the seed metering wheel assembly 312 provides a hopper for receiving a quantity of seeds to be treated from the assembly 2, with the seeds flowing by gravitation into the area immediately above the seed metering wheel 400. This is monitored by a pair of proximity sensors 388 and 390 respectively located adjacent the weldment openings 396 and 398. Thereupon, the seeds pass through the openings 396, 398, and thence through the metering wheel 400 and the stationary openings 436, 438, and 440 of plate assembly 323. The quantity of seeds is then finally directed into and through the delivery chute 324 to the atomizer 314 of seed treater assembly 4.

The passage of seed through the metering wheel 400 is of prime importance. That is, as the wheel 400 rotates, the especially designed and configured seed metering openings 418, 420, and 422, and the corresponding opening-defining rib sections 418, 420a, and 422a continually present a substantially constant open area. That is to say, at virtually every instant over a given time period, the wheel 400 gives an effective through opening, which is of substantially constant area. Furthermore, owing to the preferred, differently sized openings 418-422, the staggered orientation thereof, and the locations of the defining rib sections 418a-422a, at no instant is there a wholly unobstructed seed flow path through the wheel 400. As such the tendency of prior spoke-type seed metering wheels to cause a buildup of seed, followed by presentation of a completely unobstructed seed flow path with consequent surging or “dumping” of seed, is substantially eliminated. The presence of the stationary brushes 392 and 394 assists in the desirable operation of the metering wheel 400, by acting as a leveling device in order to successively level the upper surfaces of quantities of seeds retained by the ring 408, so that substantially constant seed weights are present at the inlet face of the metering wheel 400. Consequently, the seed metering wheel assembly 312 of the invention provides a substantially constant weight and volumetric flow of seed to the downstream seed treater.

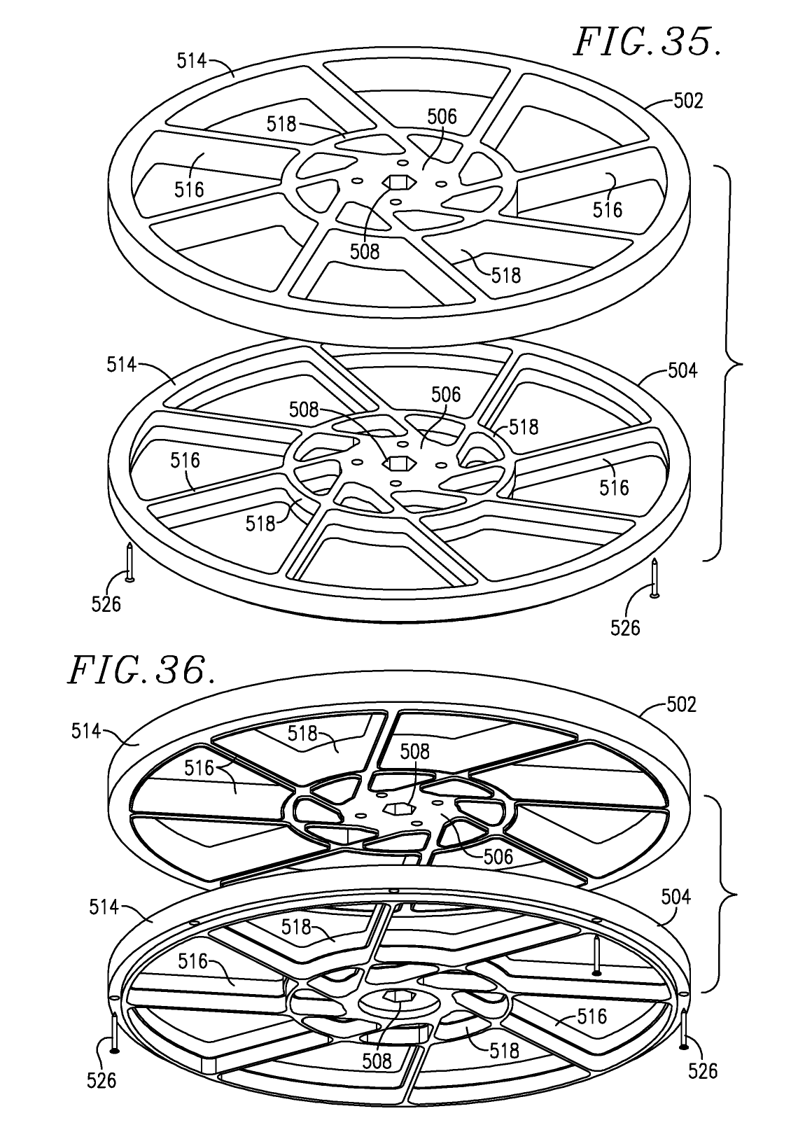

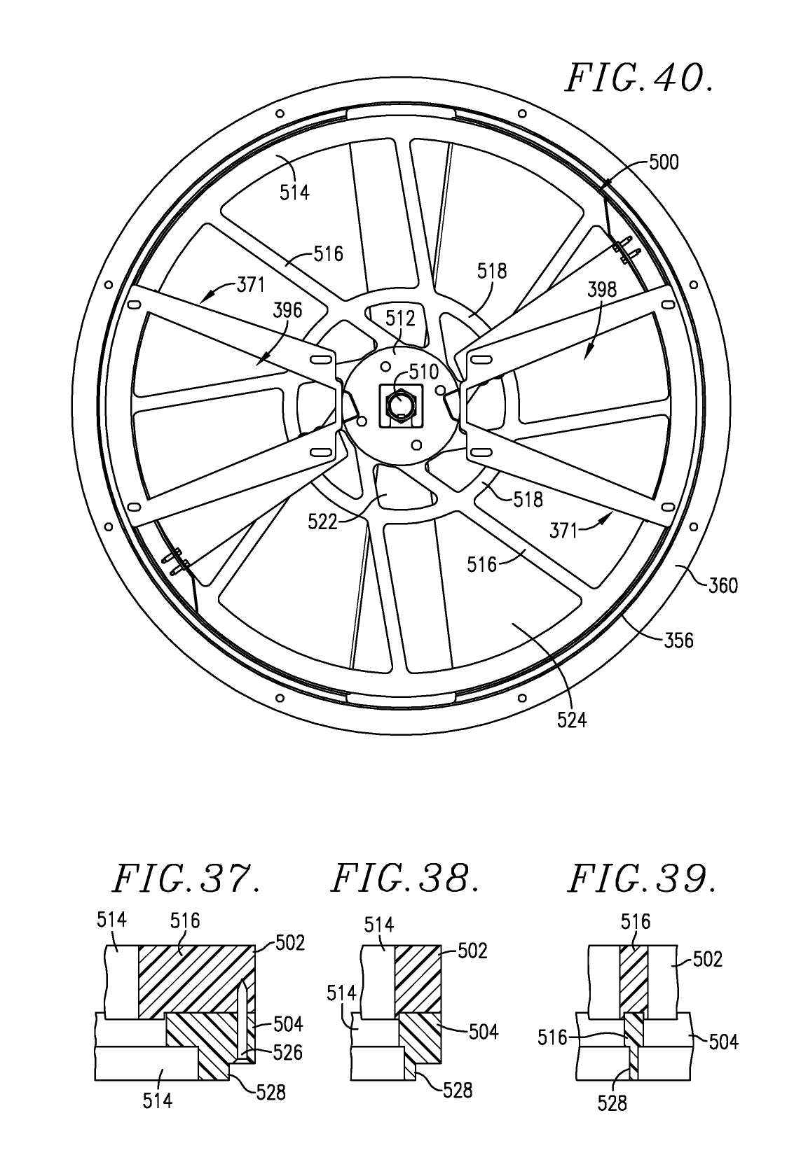

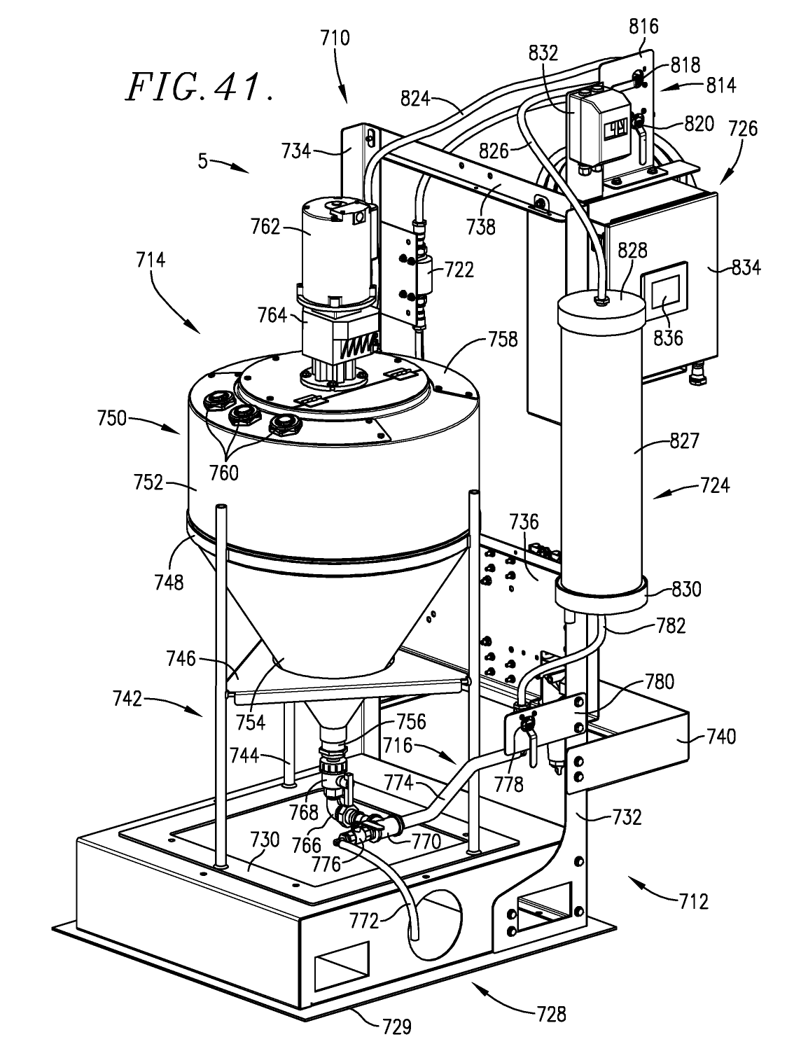

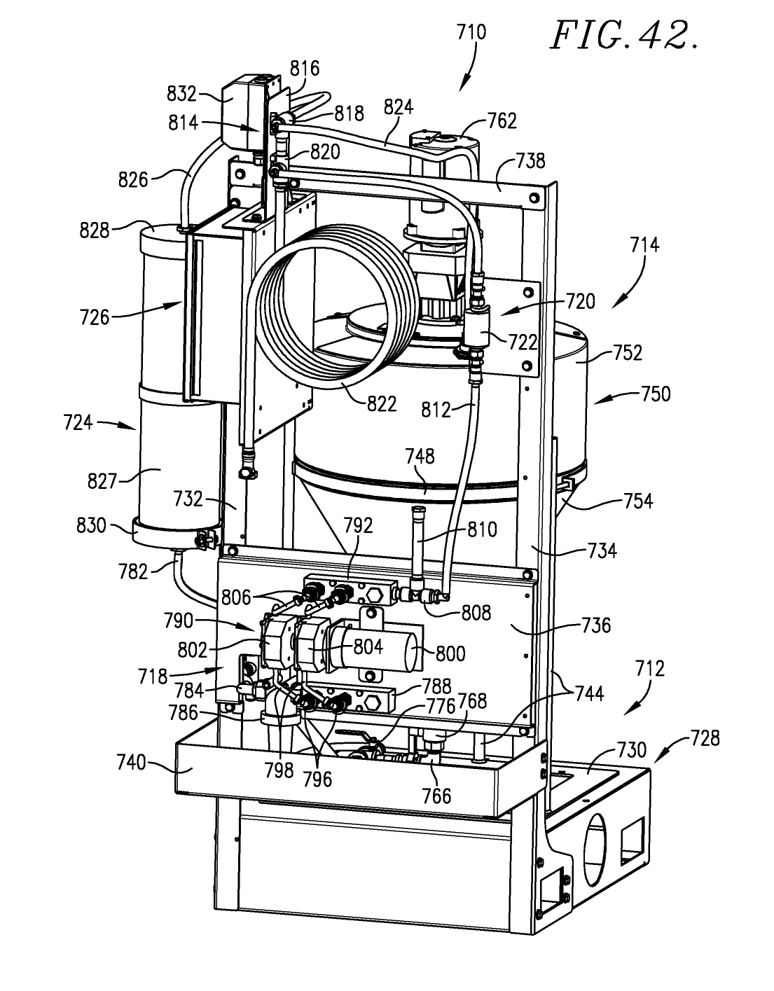

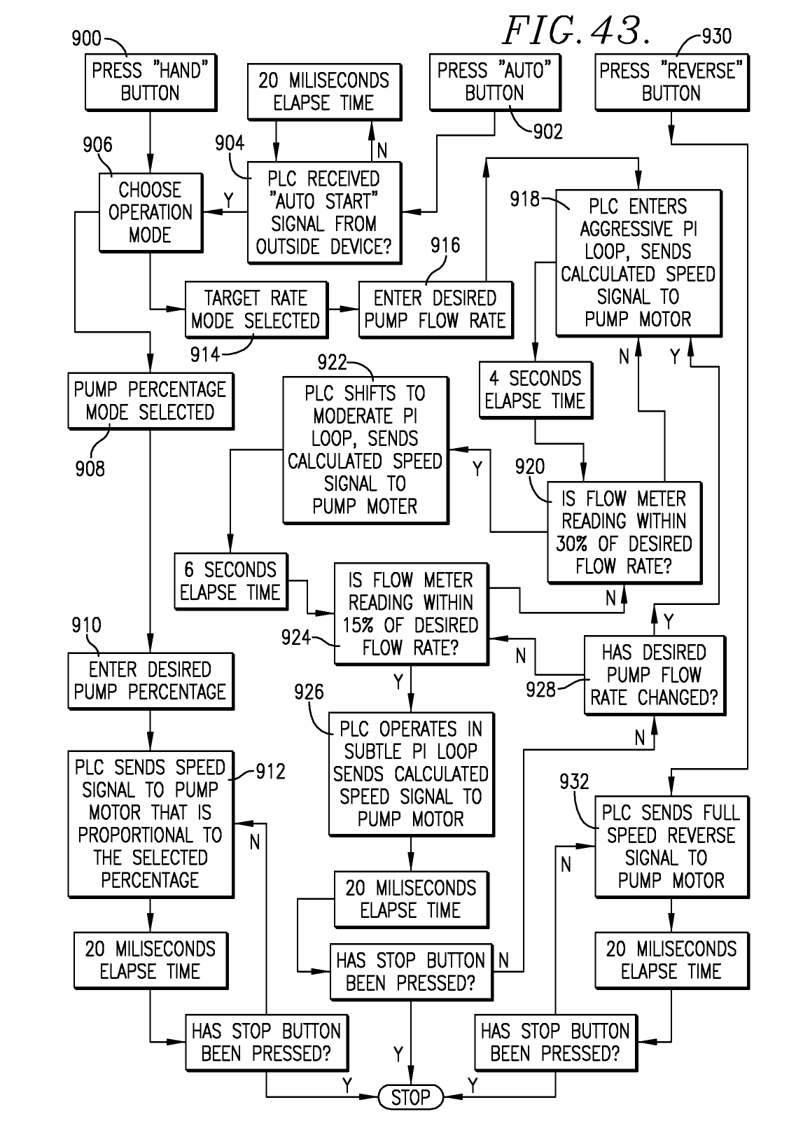

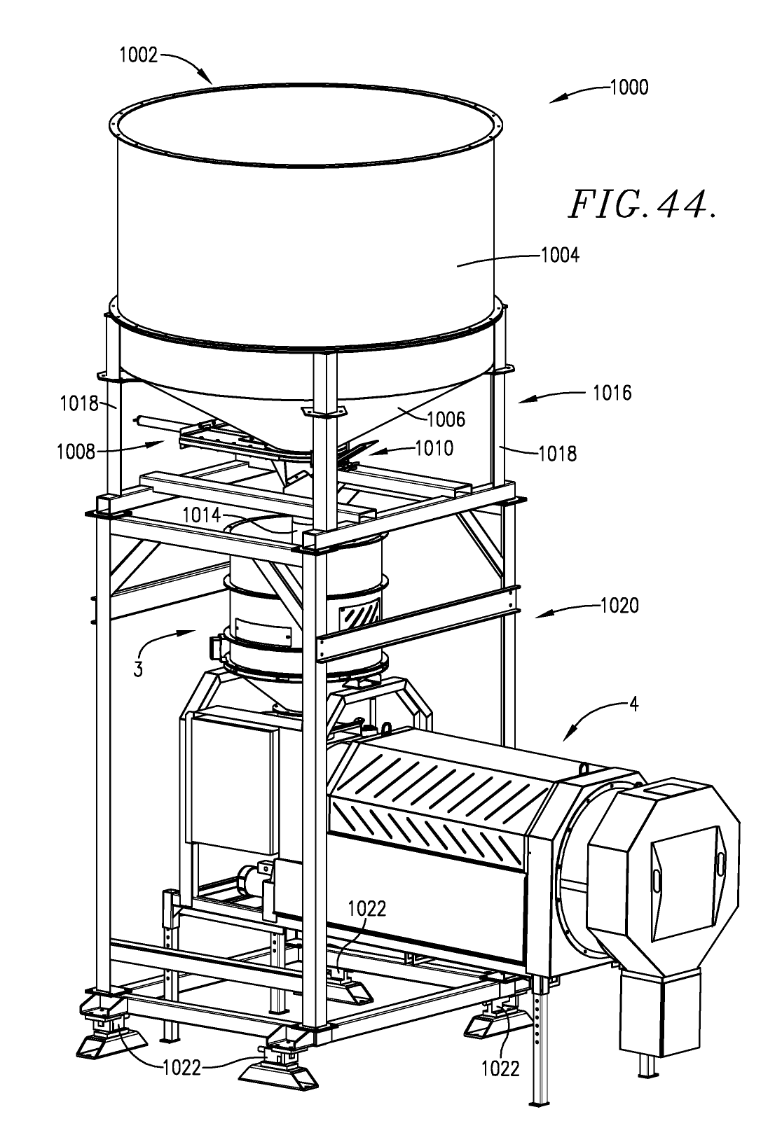

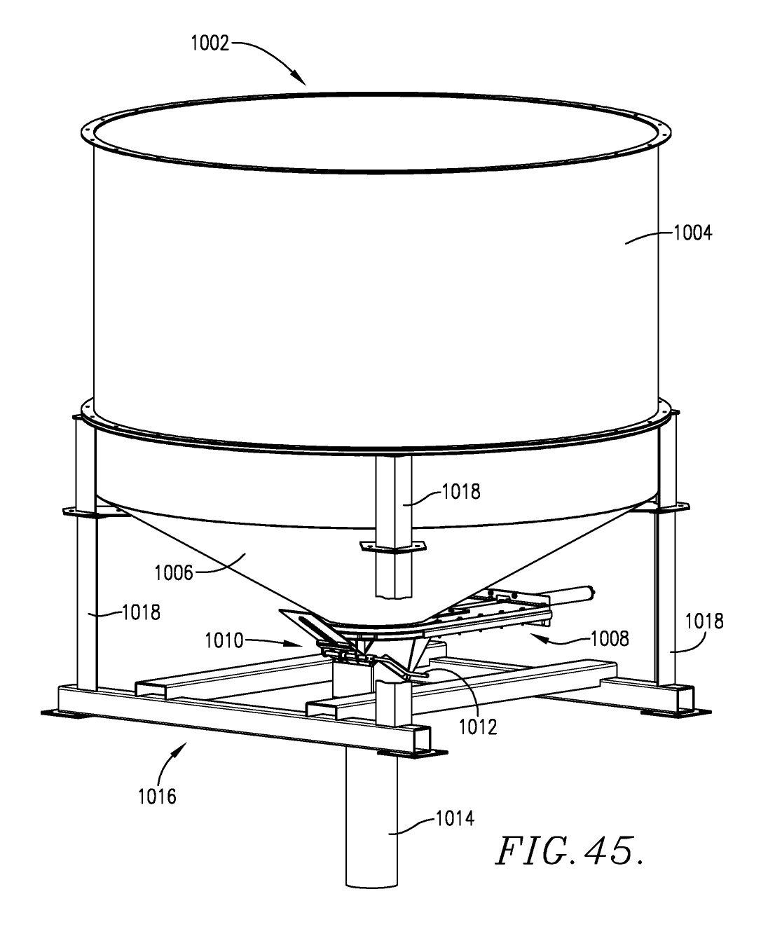

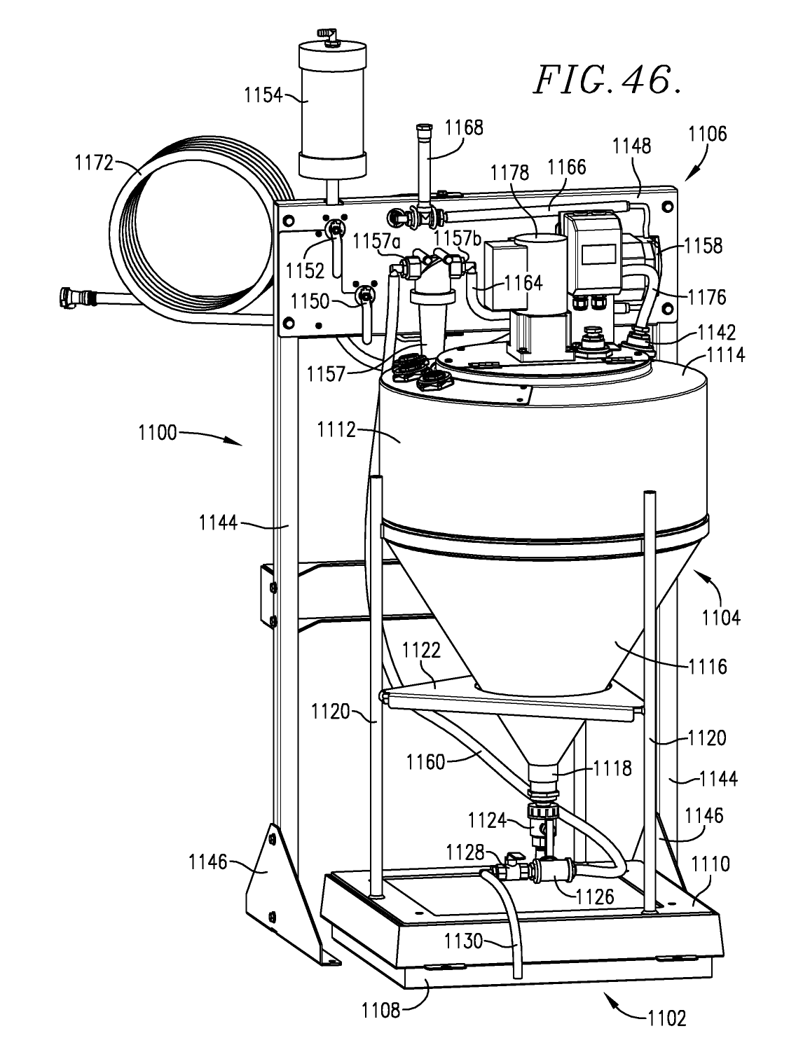

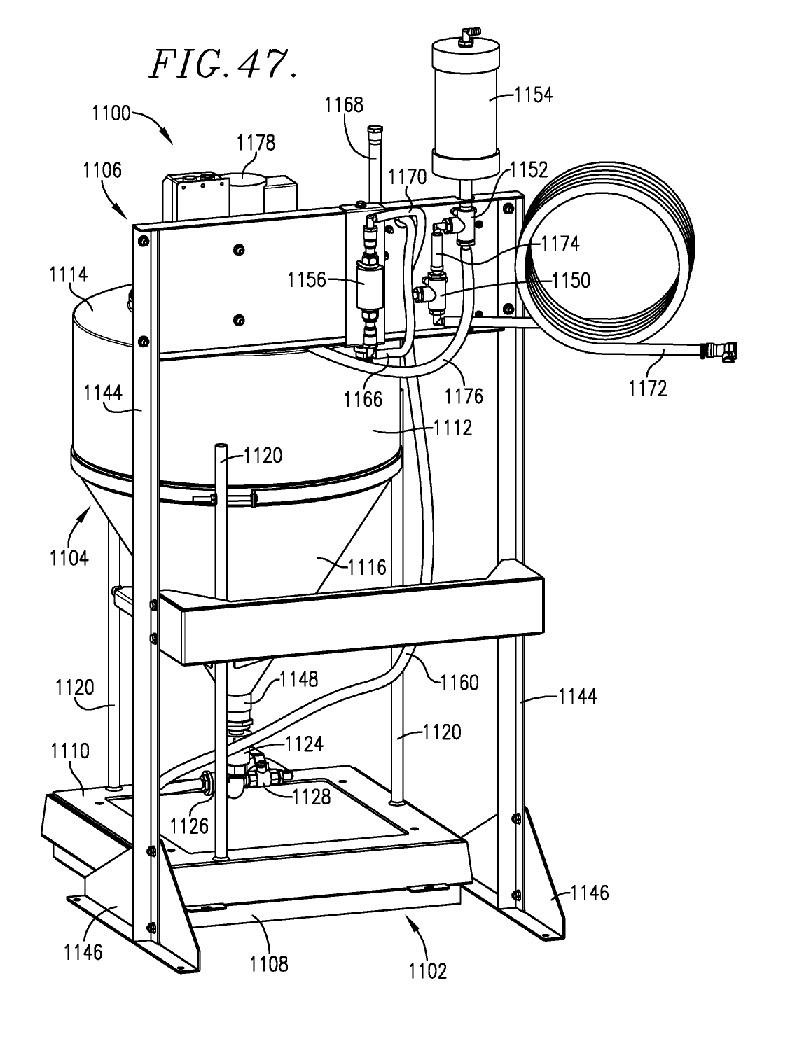

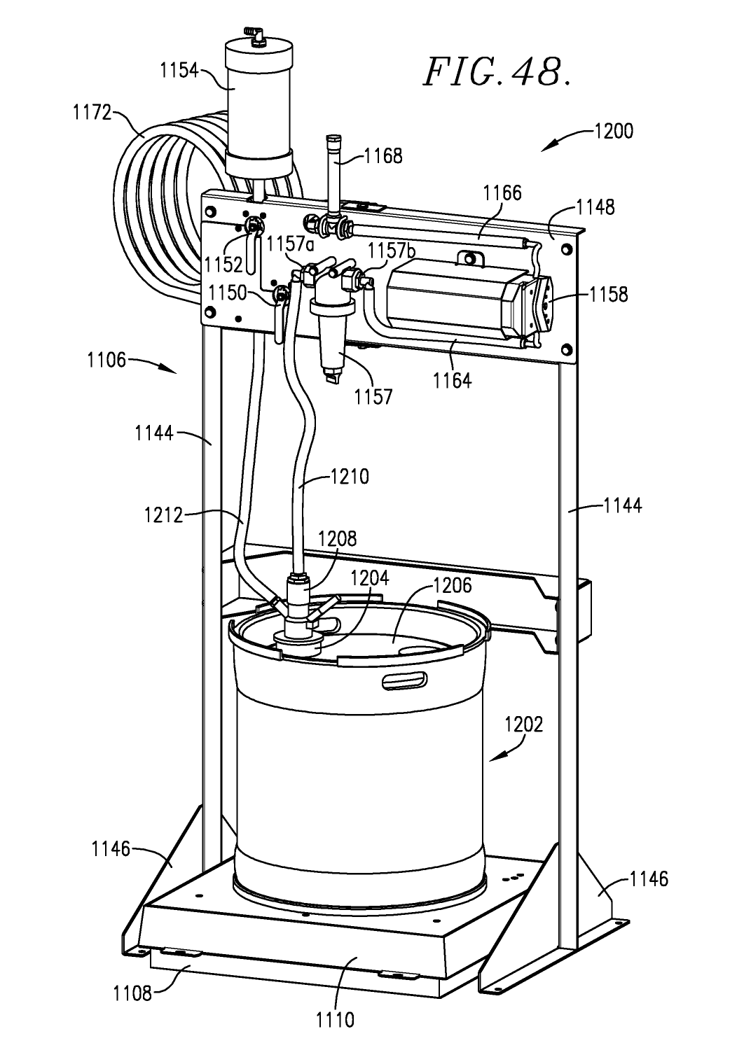

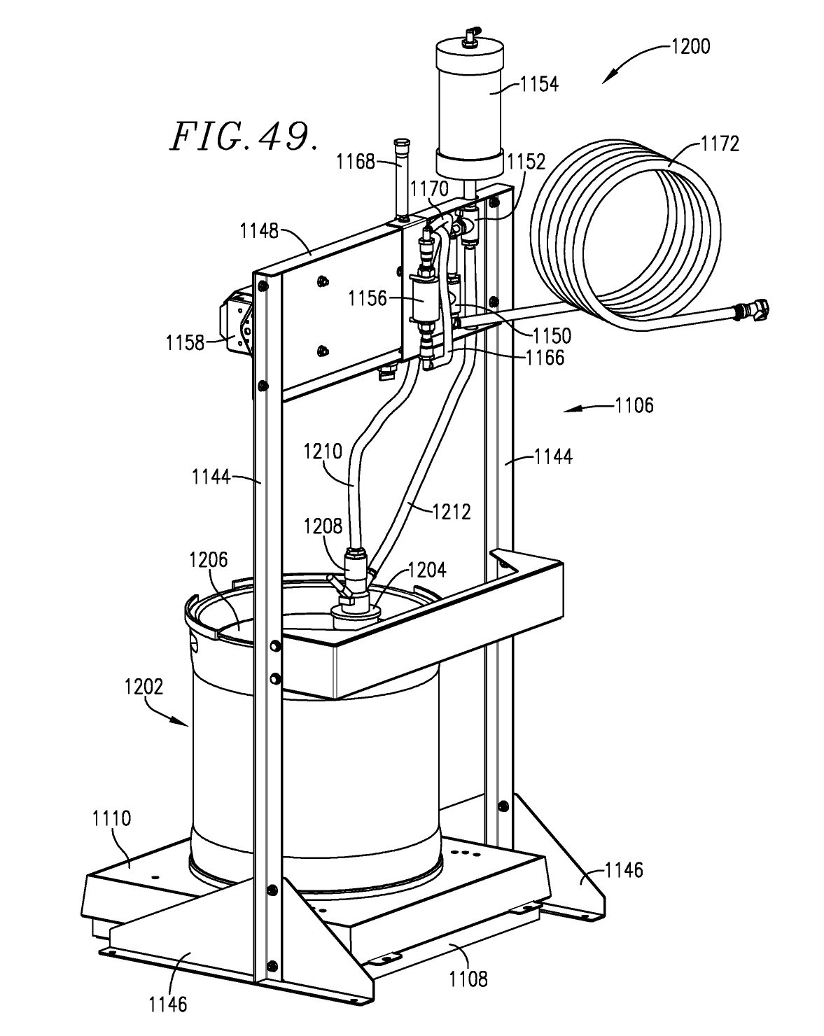

Turning to FIGS. 33-40, an alternate seed metering wheel 500 is depicted. The wheel 500 has a different design as compared with the previously described seed metering wheel 400, and is configured for use within the overall seed metering assembly 322. The wheel 500 is a simpler design which can be manufactured at a lower cost as compared with wheel 400.

In particular, the wheel 500 is of composite design, comprising upper and lower, interconnected, synthetic resin wheel plates 502 and 504. The interconnected plates 502, 504 cooperatively define a central hub 506 having a hexagonal drive opening 508 therethrough. As illustrated in FIG. 33, a rotatable drive shaft 510, identical with previously described shaft 424, extends into the opening 508 in order to rotate wheel 500 by means of motor 364 and gear box 366. To this end, a hub plate 512 also forms a part of the drive assembly for the wheel 500.

The overall wheel 500 includes an outermost rim 514, a total of eight elongated ribs 516 which extend from central hub 506 to rim 514, and a circular reinforcing ring 518 between hub 506 and rim 514. It will be observed that the ribs 516 lie along respective, non-diameter chord lines 520 (FIG. 34) which are equally spaced about the wheel 500. In this fashion, the wheel 500 presents a series of eight somewhat triangular inner openings 522 between central hub 506 and reinforcing ring 518, and eight larger, generally quadrate openings 524, each outboard of an opening 522 and located between ring 518 and rim 514.

In more detail, it will be seen that plates 502 and 504 are in face-to-face contact, and are interconnected by means of screws 526. As best illustrated in FIGS. 36-39, the lower wheel plate 504 has a reduced thickness downwardly extending circular contact lip 528 forming a part of rim 514; likewise, the lower extents of the ribs 516 are of reduced thickness. Stated otherwise, the thickness of the lower edge of the lower plate 504 i thinner than the thickness of the upper edge of the upper plate 502. These features serve to reduce the fiction between the wheel 500 and the underlying structure of assembly 322, while also providing sufficient mechanical strength for the wheel.

As explained previously, the wheel 500 is an alternate design, which is fully compatible with the components of assembly 322. This is best illustrated in FIG. 40, which depicts the weldmemts 371 defining the through-openings 396, 398 serving as seed entrance openings for the wheel 500.

The operation of wheel 500 is exactly as previously described in connection with wheel 400. At virtually every instant over a given period of time, the wheel 500 presents effective through-openings of substantially constant area, and in no instance is there a wholly unobstructed seed flow path through the wheel 500.

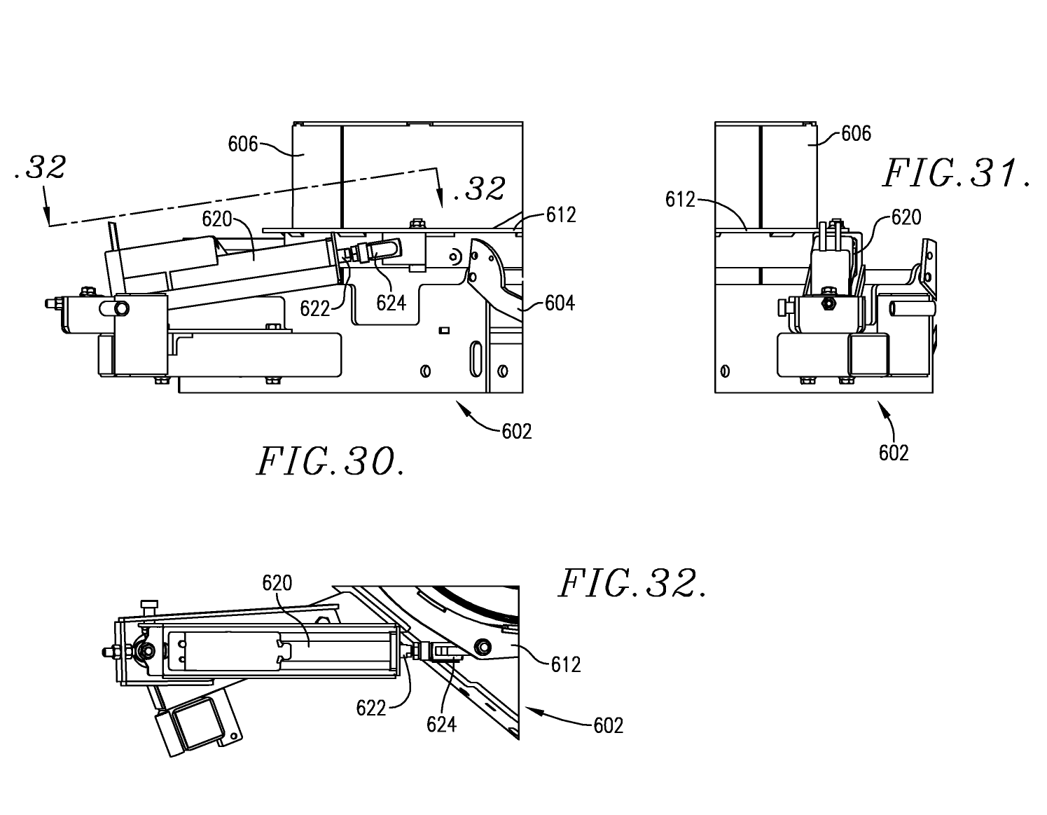

An alternate seed metering assembly 3 is identical with the above-described structure, except that the seed metering wheel assembly 12 is eliminated and a rotary gate assembly 600 is positioned between assemblies 2 and 4 (FIGS. 29-32).

While the seed wheels 400 and 500 have been described in detail above, it should be understood that the system 1 can accommodate virtually any type of seed wheel. For example, USC, LLC of Sabetha, Kans. has heretofore made and sold a conventional eight-pocket seed wheel design, which can be used in lieu of the wheels 400 or 500. That is, such a conventional wheel may be directly used with the assemblies 312 and 320, so long as the control assembly 6 is appropriately configured.

The assembly 600 includes box-like support structure 602 having a lever lock 604 permitting interconnection between the underside of assembly 600, and the inlet of the seed treater atomizer. A circular outer wall 606 extends upwardly from support structure 602 and includes three circumferentially spaced apart oblique cam slots 608. A rotatable gate 610, provided with an outwardly extending circular flange 612, is provided inboard of the wall 606 and is designed to move between a fully closed position of FIG. 29 to an open position wherein seed will flow through the assembly 600. An internal diverter assembly 614 is located within the confines of gate 610, including a lower, substantially conical seed diverter 616 and upper diverter cross walls 618.

A piston and cylinder actuator 620 is positioned outboard of the gate 610 and includes a reciprocal piston rod 622 having an endmost clevis 624. The clevis 624 is operatively connected to flange 612, as best seen in FIG. 32. Three cam bushings (not shown) are secured to gate 610 and are respectively located within a cam slot 608. When it is desired to open the assembly 600, the actuator 620 is energized to extend the rod 622. This serves to rotate the gate 610 the desired extent, with the cam bushings riding within the slots 608. Such gate rotation creates a gap below the gate 610 to permit seed flow. It will be appreciated that the diverter assembly 614 serves to divide and divert down-coming seeds outwardly towards the circular gap created on rotation of gate 610.

### Assembly 5—Liquid Treatment Delivery Assembly

Turning now to FIGS. 41-42, a liquid treatment delivery assembly 5 is shown, in the form of a self-contained pump stand 710. The stand 710 broadly includes a supporting frame assembly 712, a tank assembly 714, a first valve and conduit assembly 716, a pump and conduit assembly 718, a second valve and conduit assembly 720 with an in-line flow meter 722, a calibration tube 724, and control assembly 726. The pump stand 710 is designed to bold liquid chemical(s), typically used for seed coating, and to deliver calibrated amounts of the chemical(s) to a seed treater or the like. The pump stand 710 is completely self-contained, and has a number of features greatly facilitating accurate dispensing of chemical(s).

In more detail, the frame assembly 712 includes a box-like, quadrate base 728 presenting an uppermost mounting plate 730 and having a pair of upstanding, opposed frame arms 732 and 734 secured to the rear end of base 728. An equipment mount plate 736 extends between the arms 732, 734, and an uppermost rigidifying cross-brace 738 interconnects the arms 732, 734 at their uppermost ends. A generally U-shaped bumper 740 is secured to the anus 732, 734 and extends rearwardly therefrom.

The tank assembly 714 includes a triangular tank base 742 comprising three upstanding legs 744 secured to the mounting plate 730 with a generally triangular, intermediate apertured support plate 746 secured to the legs 744 above mounting plate 730. The upper end of the base 742 includes the generally circular hoop 748 likewise supported by the legs 744 adjacent the upper ends thereof. The base 742 is designed to support a conical-bottom liquid tank 750 including a generally circular upper wall 752 and a substantially frustoconical lower wall 754 having a lowermost liquid outlet 756. An upper tank cover 758 is positioned atop the circular wall 752 in order to close the tank 750 and to allow filling thereof through the ports 760. The cover 758 also supports an agitator drive motor 762 with an associated gear box 764. A central agitator shaft (not shown) is operably coupled with gear box 764 and extends into the confines of tank 750. The agitator shaft has conventional mixing elements so that the chemical(s) within tank 750 may be agitated to ensure proper mixing thereof.

The first valve and conduit assembly 716 includes a delivery pipe 766 operably coupled with tank outlet 756 and equipped with a diverter valve 768. The output end of pipe 766 is equipped with a tee 770. A drain conduit 772 is secured to one end of the tee 770, whereas a liquid delivery conduit 774 is secured to the opposite end of tee 770. The drain conduit 772 is also equipped with a two-way diverter valve 776. The assembly 716 also includes a two-way diverter valve 778 supported on a forwardly extending plate 780. The delivery conduit 774 is secured to the input of valve 778. A pair of output conduits 782 and 784 are also coupled with valve 778. Output conduit 782 extends to and is coupled with calibration tube 724, whereas output conduit 784 extends to and is connected with a liquid filter 786 secured to the rear face of mounting plate 736.

The pump and conduit assembly 718 includes a lower manifold block 788 secured to the rear face of equipment mounting plate 736, an intermediate pumping assembly 790, and an upper manifold block 792. The filter 786 is coupled to lower manifold block 788 for delivery of filtered chemicals to a pair of outputs 796, each equipped with a short conduit 798. The intermediate pumping assembly 790 includes an electrical drive motor 800 and a pair of pumping heads 802 and 804. The output of the head 804 is delivered through short conduits 806 to upper manifold block 792, which delivers the pumped liquid through output pipe 808 equipped with an upstanding turbulence-minimizing pipe 810.

The second valve and conduit assembly 720 includes a liquid conduit 812 coupled with the end of pipe 808 and equipped with the in-line flow meter 722, and a dual valve assembly 814 mounted on an upstanding plate 816 and having upper and lower valves 818 and 820. The upper end of conduit 812 is coupled with the lower valve 820, and the outputs thereof are respectively coupled with a coiled liquid delivery line 822, which is coupled to a downstream seed treater or other device, and to the input of upper valve 818. The outputs of valve 818 are respectively coupled with a recirculation conduit 824 leading to tank 750, and a calibration tube conduit 826.

The calibration tube is in the form of an elongated upright tube 827 equipped with upper and lower end caps 828 and 830, and a volumetric scale (not shown) imprinted on the body of the tube 827. As illustrated, the conduit 826 is secured to the upper end cap 828, whereas output conduit 782 is secured to lower end cap 830.

The control assembly 726 includes a conventional electrical junction box 832 coupled with control assembly 6. Such may be though a direct connection to control assembly 6 or to a dedicated digital controller 834 equipped with a touch pad output 836 forming a part of assembly 6. The sequential operation of the pump stand 710 is governed and controlled by the controller 834, and this operation will be described in detail in connection with FIG. 43.

In the preferred form of the pump stand 710, a lowermost weigh scale 729 is used (or the mounting plate 730 is replaced with a weight scale) in order to provide continuous monitoring of the weight of chemical(s) within the tank.

### Operation of the Pump Stand 710

There are four basic modes of operation for the pump stand 710, namely initial recirculation of liquid, pump calibration, normal calibrated delivery of liquids to the downstream seed treater or other device, and a reverse or flush operation.

The recirculation mode would typically be used during startup of the system 1 in order to ensure that the liquid chemicals within the tank 750 are uniformly mixed. In order to recirculate, the agitation drive motor is operated to mix the chemicals within tank 750. Also, the valve 768 is open to prevent delivery of liquid through outlet 756 and pipe 766, the valve 776 is closed, and the valve 778 is opened to deliver liquid through filter 786, lower manifold block 788, and pumping heads 802, 804. The lower valve 820 is set to deliver the pumped liquid to upper valve 888, which is set to deliver through recirculation conduit 824, back to tank 750. It will thus be seen that operation of the pump assembly 790 draws liquid from the tank 750 and ultimately recirculates this fluid back to the tank.

After adequate circulation is achieved, the stand 710 may be used if needed to calibrate the flow rate of the pumping assembly 790 in order to deliver consistent volumes of liquid per unit time through the delivery line 822. Specifically, in this mode of operation, the upper valve 818 is positioned so as to deliver liquid through the calibration tube conduit 826. This continues for a predetermined period of time (e,g., one minute), and the amount of liquid collected with calibration tube 724 is determined using the volumetric scale markings on tube 827. If the target output of the pumping assembly 790 is 50 ounces/minute, this can be determined using the collected amount of liquid. If the flow rate is either too high or too low relative to the desired output rate, the controller 834 can be operated to compensate for the difference. In this operation, the touch screen is tapped until a calibration screen appears, whereupon the underage or overage flow rate is adjusted to the target rate. The controller 834 thus provides a signal u(t) to the pumping assembly 790 to speed up or slow down, as the case may be, so as to deliver a consistent flow rate output to the downstream seed treater or the like. The controller 834 is also provided with continuous flow rate data owing to the presence of the in-line flow meter 722. Once calibration is achieved, the valve 778 is manipulated so that the pumping assembly 790 removes the liquid from the calibration tube 724, which is diverted through the pumping assembly 790, as described previously.

After optional calibration, the pump stand 710 is typically used in a normal delivery mode. This requires only that the valve 778 be manipulated after emptying of the calibration tube 724 so that the pumping assembly 790 draws liquid from the tank 750, and manipulation of lower valve 820 so that the pumped liquid is directed to the delivery line 822 for downstream use.

At the end of a given run, it may be necessary to change the liquid chemical(s) within tank 750 in order to deliver different chemical(s) for a subsequent run. In such a case, the valve 776 is opened to deliver liquid to the drain conduit 772, and the pump drive motor 800 is reversed. This serves to remove all liquids within the pump assembly and other conduits, while the material remaining in tank 750 is allowed to flow by gravitation through the conduit 772.

Before a fresh batch of liquid chemical(s) is delivered to tank 750, it may be desirable to flush the entire system. Water or other cleaning fluids are directed to tank 750, whereupon the pump stand 710 is operated in recirculation mode, as described above, followed by a second flush operation. The tank 750 can then be refilled with the necessary liquid chemical(s) for the subsequent run.

### Automated Control of Pump Stand 710

As mentioned above, the controller 834 governs operation of the pump stand 710 in conjunction with the overall control assembly 6. The controller 834 is preferably an electronic integrated circuit and may be a general use, commercial off-the-shelf computer processor, a programmable logic device configured for operation with the pump stand 710, or an application specific integrated circuit (ASIC) especially manufactured for use with the pump stand 710. The controller 834 may include two or more separate integrated circuits cooperating to control operation of the pump stand 710, and may include one or more analog elements operating in concert with or in addition to the electronic circuit or circuits. The controller 834 may include or communicate with a memory element configured to store data, instructions, or both for use by the controller 834. The controller 834 is also referred to herein as a programmable logic controller or PLC.

An exemplary sequence of control steps performed by the controller 834 is illustrated in the flow diagram of FIG. 43, which is used when the liquid coating delivery system 5 is operated either in the Flow Rate Metering Mode or in the Combined Mode illustrated in FIG. 2B. In such instances, the FIG. 43 control routine is used in a repeating loop to maximize the accuracy of the assembly 5. Operation of the controller 834 may begin manually in response to a user input or automatically in response to a start signal received from an external device such as a seed treater. A user may manually launch a treatment application process by engaging a button or other user interface element designated for that purpose, as depicted in block 900, or may place the controller 834 in automatic start mode, as depicted in block 902. When the controller 834 is in the automatic start mode it automatically launches the process upon receiving the start signal, as indicated in block 904.

Whether the controller 834 begins the process in response to a manual input from a user or in response to a start signal, it first determines a mode of operation, as depicted in block 906. The controller 834 may determine the mode of operation by, for example, prompting the user to select the mode or by retrieving a previously-stored setting indicating the mode of operation. If a pump percentage mode is selected, as depicted in block 908, the controller 834 prompts the user to enter a desired percentage, as depicted in block 910, corresponding to a percentage of the maximum output or speed of the motor. The controller 834 then communicates the control signal u(t) to the pump motor to cause the pump motor to operate at the desired percentage, as depicted in block 912, until the user stops the motor. The pump percentage mode may be used, for example, during initial recirculation, while the target rate mode may be used during pump calibration and normal calibrated delivery.

If the controller 834 operates in the target rate mode 914 the controller 834 determines a flow rate setpoint, as depicted in block 916. The flow rate setpoint is the desired or target application flow rate. The controller 834 may prompt the user to submit the setpoint, for example, or may retrieve it from memory or receive it from an external device. The flow rate setpoint may change during operation, as explained below.

When the controller 834 has determined the flow rate setpoint, it then controls the pump motor to apply treatment as closely as possible to the setpoint. More specifically, the controller 834 determines a flow rate error e(t) corresponding to a difference between the actual flow rate (as indicated by the in-line flow meter 722) and the setpoint and uses a feedback control loop function to modify the actual flow rate to minimize the error. The value of e(t) may be expressed in various ways, including as a raw difference or as a percentage of the setpoint. The controller 834 applies a feedback control loop to control the pump motor according to a tiered control scheme wherein a more aggressive (faster) response is applied to greater values of e(t) and a more conservative (slower and more stable) response is applied to smaller values of e(t). More particularly, the controller 834 uses a multi-tiered proportional-integral-derivative (“PID”) or proportional-integral (“PI”) control loop to manipulate process control inputs (e.g., a motor control signal) to minimize e(t). In some embodiments, the controller 834 generates a pump motor control signal according to the following control equation:

$$u ( t ) = {K}_{p} [ e ( t ) + \frac{1}{{T}_{n}} {\int }_{0}^{t} e ( τ ) d ( τ ) + {T}_{v} \frac{d}{d t} e ( t ) ] + {U}_{Offset}$$

wherein

u(t) is the pump motor control signal;

e(t) is the error function defined above;

Kₚ is a proportional coefficient;

Tₙ is an integral coefficient;

Tᵥ is a derivative coefficient; and

U_{Offset} is an offset variable for the motor control signal.

The controller 834 is configured to manipulate the values of Kₚ, Tₙ and Tᵥ to shift the PID control function between a more aggressive response and a more conservative response. Generally, increasing the value of Kₚ increases the aggressiveness of the control loop while increasing the value of Tₙ decreases the aggressiveness of the control loop. The values of Kₚ and Tₙ will depend on other, implementation-specific variables such as the number of pump heads associated with the pump motor. The value of U_{Offset} may be specific to particular application chemicals and/or particular application processes.

In one preferred embodiment, the variable is set to zero to entirely eliminate the derivative term from the equation such that the controller 834 implements a PI control function. Alternatively, the value of Tᵥ may be set to a very low number to minimize the influence of the derivative term on the output. By way of example, for aggressive operation, the value of Kₚ may be within the range of from about 0.8 to about 0.5, for moderate operation may be within the range of from about 0.05 to about 0.2, and for conservative operation may be within the range of from about 0.02 to about 0.5. For aggressive operation, the value of Tₙmay be within the range of from about 1.0 to about 4.0, for moderate operation may be within the range of from about 2.0 to about 5.0, and for conservative operation may be within the range of from about 4.0 to about 6.0. Table 1 illustrates exemplary values of Kₚ and Tₙ for aggressive, moderate and conservative loops when the pump motor is driving one pump head, two pump heads and three pump heads.

TABLE 1

| | 1 Pump Head | 2 Pump Heads | 3 Pump Heads |
|---|---|---|---|
| Aggressive Loop | Kₚ = 0.2 | Kₚ = 0.15 | Kₚ = 0.1 |
| | Tₙ = 2.0 | Tₙ = 2.5 | Tₙ = 3.0 |
| Moderate Loop | Kₚ = 0.1 | Kₚ = 0.085 | Kₚ = 0.075 |
| | Tₙ = 3.0 | Tₙ = 3.5 | Tₙ = 4.0 |
| Conservative Loop | Kₚ = 0.01 | Kₚ = 0.01 | Kₚ = 0.01 |
| | Tₙ = 5.0 | Tₙ = 5.0 | Tₙ = 5.0 |

Returning again to FIG. 43, the controller 834 begins operation by entering the aggressive control loop and communicating the control signal u(t) to the pump motor, as depicted in block 918. The controller 834 periodically compares the actual flow rate with the setpoint to determine if e(t) has fallen below an aggressive threshold, as depicted in block 920. The aggressive threshold may be, for example, between about 20% and about 40%, and may particularly be about 25%, about 30% or about 35%. If the actual flow rate has fallen below the aggressive threshold, the controller 834 shifts to the moderate control loop and continues communicating the control signal u(t) to the pump motor, as depicted in block 922. The controller 834 periodically compares the actual flow rate with the setpoint to determine if e(t) has fallen below a moderate threshold, as depicted in block 924. The moderate threshold may be, for example, between about 10% and about 20%, and may particularly be about 12%, about 15% or about 18%. If e(t) has fallen below the moderate threshold, the controller 834 shifts to the conservative control loop and continues communicating the control signal u(t) to the pump motor, as depicted in block 926. If e(t) has not fallen below the moderate threshold, the controller 834 returns to block 920 to determine if e(t) is below the aggressive threshold.

When the controller 834 is operating in the conservative control loop, it remains in the conservative control loop until the user presses a stop button, until the setpoint changes as depicted in block 928, or until e(t) exceeds the moderate threshold. If the setpoint changes the controller 834 shifts back into the aggressive control loop to bring the actual flow rate near the setpoint as quickly as possible, then shifts back into the moderate and conservative control loops as e(t) decreases, as explained above.

The user may initiate the reverse or flush operation set forth above by engaging a button or other user interface element designated for that purpose, as depicted in block 930, wherein the controller 834 drives the pump motor in reverse, as depicted in block 932. The controller 834 continues driving the pump motor in reverse until the user presses a stop button.

The controller 834 may store operational parameters associated with particular chemical mixtures and/or particular processes so that when a user reinitiates a process that was previously run the controller 834 recalls the parameters associated with that process, thus relieving the user of the burden of re-calibrating the pump stand 710 each time a process is run. Using the touch pad 836, for example, the user may calibrate the pump stand 710 for use with a first chemical mixture. First calibration information specific to the first chemical mixture is created and used, for example, to adjust the output of the flow meter 722. The controller 834 stores the first calibration information in the memory. When the pump stand 710 is subsequently used with a different process that involves a second chemical mixture the user calibrates the pump stand 710 for the second mixture. The controller 834 associates second calibration information with the second mixture and stores the second calibration information in memory. This process may be repeated for multiple chemical mixtures, wherein the controller 834 stores separate calibration information for each of the chemical mixtures.

Thereafter, each time the user desires to use the first chemical mixture he or she simply selects the first mixture via the touch pad 836 wherein the controller 834 retrieves the first calibration information from memory. In this manner, the controller 834 may retrieve and use operational parameters associated with any of the previously used chemical mixtures. While the discussion above has focused on the use of calibration information used to adjust the output of the flow meter 722, the operational parameters stored in memory and retrieved by the controller 834 may also be associated with any of the variables Kₚ, Tₙ, Tᵥ, U_{Offset}.

While the use of a self-contained pump stand 710 with its own logic controller 834 is preferred, the invention is not limited to such stands. For example, the system 1 can operate pump stands that do not include separate controllers and, in such cases, all calculations will be performed by the assembly 6. In one such scenario, the system can operate a liquid treatment delivery assembly equipped with a liquid weigh scale by monitoring and controlling liquid flow rates via declining mass techniques. In such a case, use is made of a pump having a predetermined equation to operate at a certain speed when pump operation is initiated. After a short period (such as 8-25 seconds), the assembly 6 compares the weigh scale's total loss in mass to its predicted loss in mass (determined by the preset flow rate and the density of the liquid) and adjusts the pump speed accordingly. In addition, the assembly 6 may operate the pump to adjust the speed thereof to accommodate accumulated inaccuracies created during earlier phases of the seed coating run. This additional correctional capability is available when using the decreasing mass mode, or the combination mode of operation.

### Alternate Assembly 1 Using a Single Batch Hopper

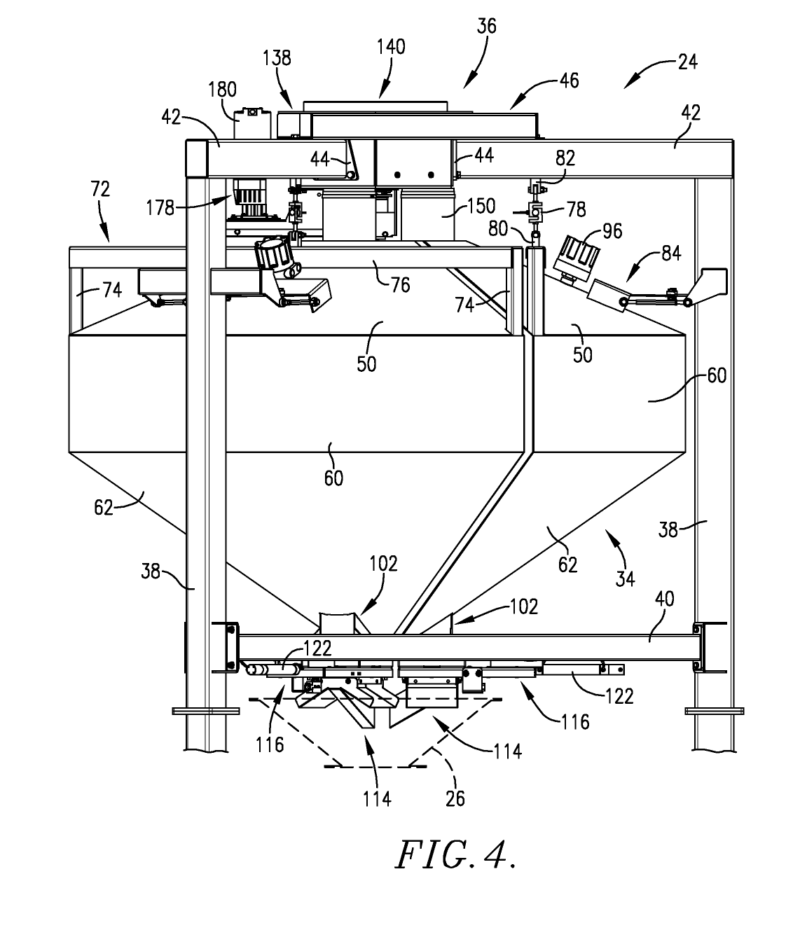

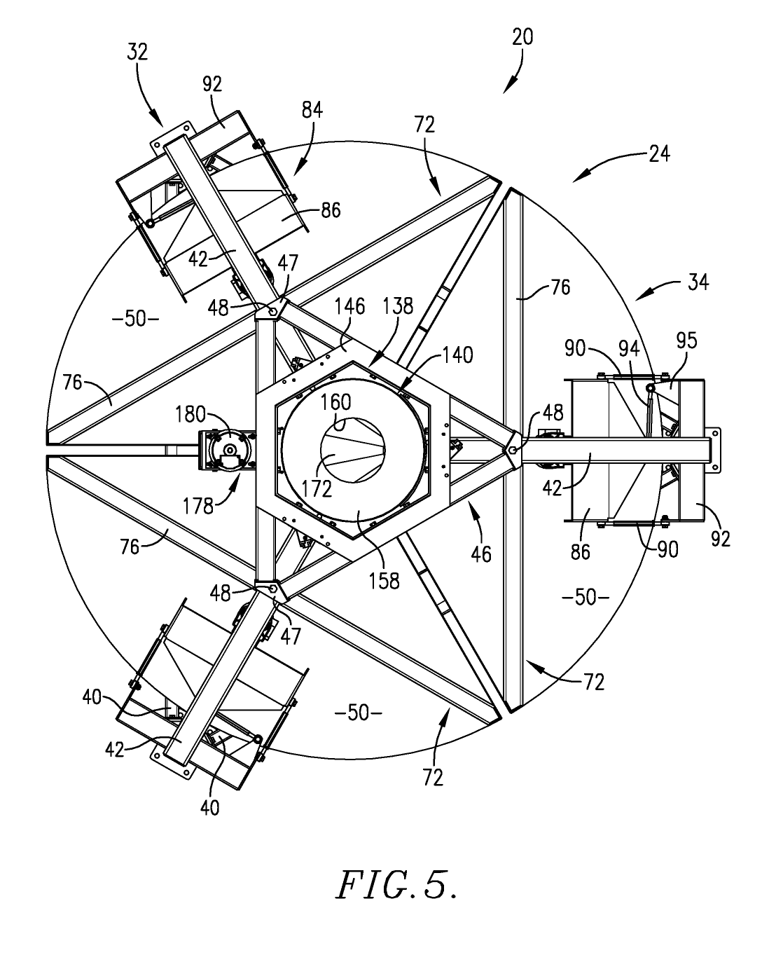

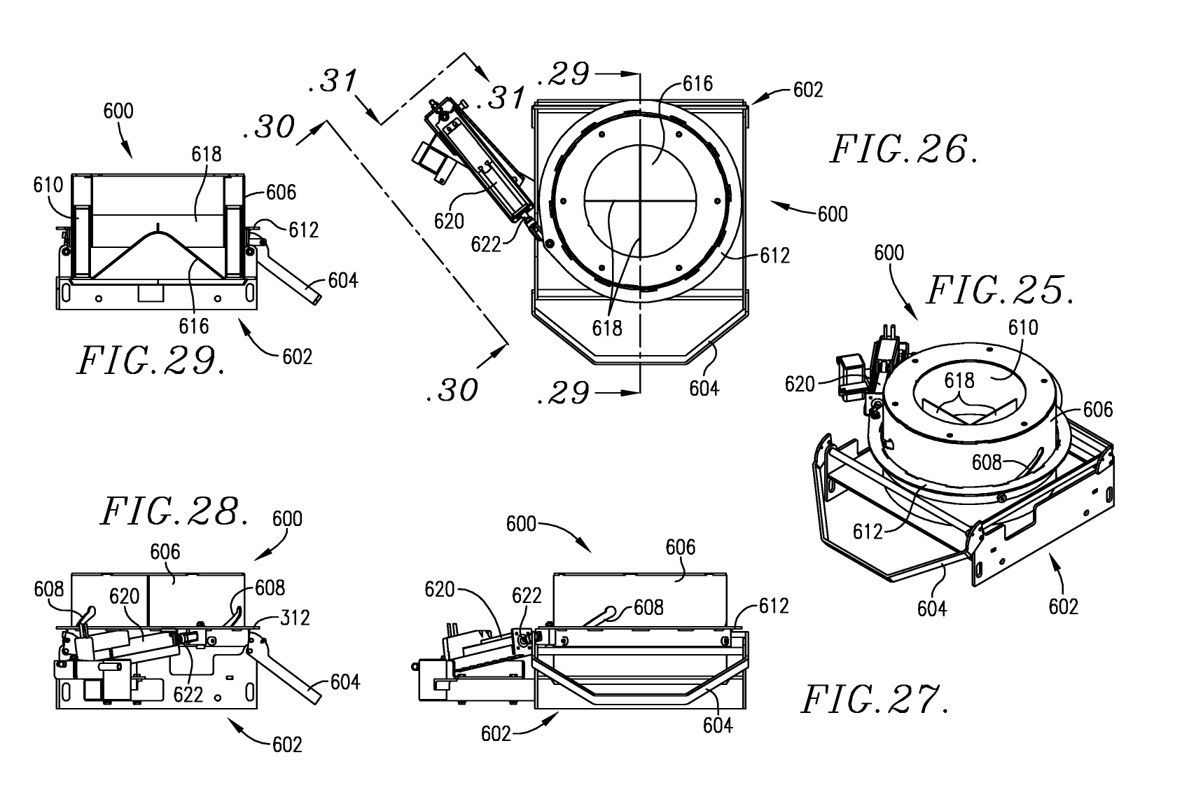

Turning to FIGS. 44-45, a seed bin assembly 1000 is depicted in FIG. 4 and broadly includes a single batch, decreasing mass seed hopper or bin 1002 situated above the previously described seed metering assembly 3 and seed treater assembly 4. Thus, the overall structure of system 1000 is identical with that illustrated and described in connection with FIGS. 3-39, except that the multiple-bin hopper assembly 24 has been replaced by the hopper 1002. Accordingly, a detailed description of the assemblies 3 and 4 need not be repeated.

The seed hopper 1002 includes an upper tubular section 1004 and a lowermost frustoconical section 1006 leading to a central outlet opening (not shown). The lower outlet opening is equipped with a principal slide gate assembly 1008, which is identical with the previously described assembly 112. The assembly 1008 is designed to selectively regulate the flow of seed from the outlet opening, as previously mentioned. In addition, a manually operated secondary slide gate assembly 1010 is provided beneath the assembly 108. This assembly is operated by means of a manual crank 1012, and is used for manual flow control if the hopper 1002 is used for feeding a conveyor or the like; therefore, this secondary assembly 1010 is not generally used in the context of the present invention. A tubular outlet pipe 1014 is situated beneath the slide gate assemblies 1008 and 1010, and is designed to deliver seed directly into the confines of seed metering assembly 3, as is readily apparent from a consideration of FIG. 44. The hopper 1002 is supported by a frame assembly 1016 having four upright legs 1018 secured to the hopper 1002, and which are in turn supported by a lower square box frame 1020. The four corners of the frame 1020 are equipped with load cells 1022.

The operation of assembly 1000 is identical to that described in connection with system 1, except that it is a batch system rather than a batch-continuous system.

### Control Assembly 6

The overall operation of system 1, using either the multiple-bin apparatus 20 or single bin assembly 1000, relies upon inputs and outputs to the control assembly 6. In general, inputs to the control assembly 6 from the seed bin assembly 24 or 1002 include the weight of seed within the bin(s), as reported by the load cells 78 or 1022, and the status (open or closed) of the discharge devices 112 and 1008 as reported by the gate sensors. The outputs to the seed bin assembly 24 or 1002 include instructions to open or close the associated discharge devices 112 or 1008.

The inputs to the control assembly 6 from the seed metering wheel assembly 3 include the rotational speed of the seed wheel and the status of the proximity sensors 388 and 390, which confirm the presence or absence of seed. The output to the seed metering wheel assembly 3 is the control of the VFD (variable frequency device) couple with seed wheel motor 364.

The inputs to the control assembly 6 from the coating apparatus 4 are the operational speeds of the atomizer 314 and drum 316, whereas the outputs are atomizer and drum VFD control.

Finally, the inputs to the control assembly 6 from the liquid coating delivery assembly 5 are the rate of pump 800, the flow rate reported by meter 722, the status of the valve 768, and the weight of liquid within the tank as reported by scale 729. The outputs include the control of the speed of the pump 800 and the position of the valve 768.

Referring to FIG. 2A, it will be noted that the seed bin assembly 24 can be operated in three alternate modes. Considering first the decreasing mass mode, the operator would first select this mode using the control assembly 6. This mode requires no calibration before the run begins, and the system will automatically and continuously self-calibrate during the seed-treating run. The system in this mode uses only the scale data derived from the load cells 78 or 1022, and requires no post-treatment calibration owing to the continuous self-calibration.

In the seed-metering mode, the operator again initiates this mode through the control assembly 6. Here the quantity of seeds is comprised of a plurality of subquantities of seeds. This system requires a “cup weight” calibration reading to be entered before seed flow begins, and a seed profile to be selected. Such cup weights are used to perform an initial “rough” calibration until further data is collected for calibration during the course of the treatment run. The system employs both the selected seed profile calibration data and the cup weight to calculate the seed flow rate and the total amount of seed treated. After completion of the treatment run, the operator can enter the known weight of the seed (usually found on the seed box label or scale data) into the calibration screen of the control assembly 6, to provide a further calibration of the seed profile.

In the combined mode, both the decreasing mass and seed metering modes are used, and again the combined mode is entered by the operator into the control assembly 6. This mode requires no calibration before the run begins, because the system will automatically calibrate itself during the run by comparing the seed wheel totalizer data to the decreasing mass totalizer data, followed by recalculating the seed profile calibration data. During the course of the run, the system uses both the selected seed profile calibration data and the cup or other subquantity weight to calculate the seed totalizer and flow rate. This system requires no calibration after completion of the treatment run, because the system automatically calibrates itself during the course of the run, as indicated previously.

Now referring to FIG. 2B, the three alternate modes of operation are depicted. In the use of the decreasing mass mode, the operator inputs the selected mode into the control assembly 6. The system requires only a density factor for the selected coating liquid before liquid flow begins, as well as a weigh scale, such as the scale 729. During liquid flow, the system uses the density data and scale readings to calculate the liquid totalizer and flow rate. Post-run calibration of the density data can be done via mass balancing, by comparing the totalizer results to the actual weight of the liquid which was used during the run.

In the flow rate metering mode, the system only employs the in-line flow meter 722. The system requires a calibration be done for each treating liquid before the seed treatment begins. This is accomplished as explained above in connection with the pump stand 710. During the treatment run, the system uses the calibration data and the flow meter readings to calibrate the liquid totalizer and flow rate. No post-run calibration is available.

In the combined mode, the scale 729 and flow meter 722 are used Again, the operator initiates this mode at control assembly 6, by an appropriate input. The system requires no calibration before the treatment run begins, because the system automatically calibrates itself during the flow of liquid by comparing the flow meter totalizer to the decreasing mass totalizer and then recalculating the calibration data. During the seed treatment, the system uses both the liquid calibration data and the flow meter readings to calculate liquid totalizer and liquid flow rate. Post-run calibration can be accomplished via mass balancing by comparing the totalizer results to the actual weight of the liquid which was used.

It will thus be seen that in both the seed bin and liquid coating delivery assemblies, system flexibility is paramount. That is, the operator can run the seed bin assembly in any mode, independent of the mode selected for the liquid coating delivery assembly. This allows for maximum flexibility of operation when service needs arise. It is particularly preferred that the combined modes of operation of the assemblies be used, because this makes use of the strengths of the decreasing mass and metering modes. That is, the seed metering mode gives essentially instant results and is mechanically robust; however, this mode, based upon calibration settings, is not as repeatable or as accurate as the decreasing mass modes. The latter are highly accurate, and self-calibrating, but are relatively slow and sensitive to environmental problems (e.g., accidental contact or upset of a scale). Therefore, the combined modes are deemed optimum.

Another advantage of the control assembly 6 is that it is designed to accommodate multiple different profiles pertaining to individual seeds and coating liquids previously run on the system 1. Thus, the controller will store in memory seed profiles for particular types of seeds and seed wheel setups, and also the operational parameters associated with particular treating liquids and flow rates. Then, when the same seeds and/or coating liquids are used, the system can call up these stored values to facilitate initial settings and calibrations of the seed treating, equipment.

### Alternate Pump Stands

Turning first to FIGS. 46-47, a pump stand 1100 may be used in lieu of the stand 710 previously described. Broadly speaking, the stand 1100 includes a weigh-scale base 1102, a conical liquid tank 1104 supported on the base 1102, and an upstanding component frame 1106 designed to support many of the operational components of the stand 1100.

In more detail, the base 1102 includes a bottom plate 1108 and a shiftable weigh plate 1110. The output of base 1102 is operatively connected with controller 6 to continuously provide weight data during the operation of the system 1.

The tank 1104 includes an uppermost, generally cylindrical section 1112 surmounted by a top cover 1114. A lowermost conical section 1116 extends below the section 1112 and terminates in a tubular outlet 1118. The tank 1104 is supported by three upright legs 1120, which are secured to the plate 1110. An apertured, generally triangular reinforcing plate 1122 is secured to the legs 1120 as illustrated. The outlet 1118 is equipped with an on-off valve 1124 leading to a tee 1126 and a secondary on-off valve 1128. A drain hose 1130 is secured to the outlet of valve 1128.

The component frame 1106 includes upstanding legs 1144, each equipped with a base 1146. A cross-frame plate 1148 extends between and is secured to the upper ends of the legs 1144. The plate 1148 supports a series of components used to control the operation of the stand 1100. Specifically, the plate 1148 supports a primary three-way valve 1150, a secondary three-way valve 1152, a calibration tube 1154, a flow meter 1156 (FIG. 47), a filter 1157 having an inlet 1157a and an outlet 1157b, and a peristaltic pump 1158.

A suction line 1160 extends from the end of the tee 1126 remote from valve 1128 and is connected to filter inlet 1157a. A line 1164 extends from the filter outlet 1157b to pump 1158. The outlet of pump 1158 passes through line 1166 to the inlet of flow meter 1156; the line 1160 is equipped with a pulse dampener 1168 as shown. A line 1170 extends from the outlet of flow meter 1156 to the inlet of valve 1150. One output line 1172 of the valve 150 is designed to be coupled with seed treater assembly 14. Another valve line 1174 extends from an outlet of valve 1150 to the inlet of secondary valve 1152. One outlet of valve 1152 is coupled with calibration tube 1154, whereas the other outlet is connected to a recirculation line 1176 back to tank 1104.

Again referring to FIG. 46, it will be seen that the cover 1114 supports and agitator motor 1178. A downwardly extending agitator shaft (not shown) extends into the confines of tank 1104 for agitating the contents thereof.

As described in connection with the stand 710, the stand 1100 has four modes of operation, namely recirculation, pump calibrations, normal calibrated delivery of liquids to the coater apparatus, and a reverse or flush operation.

During initial recirculation, the liquids are agitated via motor 1178, and the pump 1158 is operating. The valves 1150 and 1152 are manipulated so that liquid passes through the valves for return to the tank via line after adequate circulation and mixing is achieved, the pump may be calibrated in order to deliver consistent volumes of liquid per unit time through the pump outlet line 1166. In this mode, the valve 1152 is manipulated to deliver liquid to calibration tube 1154 for a predetermined period of time. Then, using the calibrations associated with tube 1154, the amount of liquid per unit time can be calculated.

After optional calibration, the stand 1100 is typically used in a normal delivery mode. This requires appropriate manipulation of the valves 1150 and 1152 so that liquid passing from pump 1158 and through flow meter 1156 is directed through outlet line 1172. Of course, the output of flow meter 1156 is operatively coupled with controller 6, as previously described.

At the end of a given run, it may be necessary to change the liquid within tank 1104 in order to deliver different liquids for a subsequent run. In such a case, the valve 1124 is operated to deliver fluid to the secondary valve 1128, and the latter is opened to deliver liquid to drain conduit 1130, and the bulk of the liquid within tank 1104 drains by gravitation for disposal.

FIGS. 48 and 49 illustrate a pump stand 1200, which is similar in many respects to the stand 1100 and, where identical components are present, like reference numerals are used. The principal difference between the stand 1200 and the stand 1100 is that the former is designed for use with an upright cylindrical chemical tote or keg 1202 rather than a conical tank 1104. Again, broadly speaking, the stand 1200 includes a weigh-scale base 1102 supporting the tote 1202, and an upstanding component frame 1106 designed to support many of the operational components of the stand 1200.

The tote 1202 does not include a lower outlet as in the case of the conical tank 1104. Accordingly, a single outlet 1204 is provided on the top plate 1206 of the tote 1202. A two-way valve 1208 is coupled with the outlet 1204. A suction line 1210 extends from one port of the valve 1208 to the inlet 1157a of filter 1157. A second line 1212 extends from the other port of valve 1208 to valve 1152. The valve 1208, together with the valves 1150 and 1152, is appropriately manipulated during the modes of operation of stand 1200 to alternately recirculate fluid therein, to calibrate using tube 1154, or to deliver fluid to line 1172. Given that the tote 1202 is separable from the pump stand 1200 and is replaced as necessary, there is no back flush operation with this pump stand 1200.

### EXAMPLE

In order to illustrate the functionality of the invention, the following hypothetical example is provided using the combined modes to control seed and coating liquid flow using the combined control modes for the seed bin(s) and liquid coating delivery assembly.

In this example, 10,000 lbs of seed are treated at a rate of 1000 lbs per minute, using the system 1. A liquid coating slurry having a density of 8 fluid oz per lb is applied to the seed at a rate of 30 oz per minute, or 3 oz per 100 lbs of seed. Initially, one of the seed bins 34 of assembly 24 has 700 lbs of seed therein, as determined by the load cells 78, and the associated slide gate 112 is closed. The other two bins are empty, and the gates 112 thereof are closed. A cup weight to pocket volume of 2.5 is inputted to the controller 6. The liquid tank 750 holds 500 lbs of slurry, or 4000 fl oz, as determined by the weigh scale 729 associated with stand 710.

The speeds of the drive motors for the atomizer 314 and drum 316 are set using controller assembly 6 in accordance with the desired seed coating rate, and the operation of the atomizer and drum begins. The pump stand 710 is in its recirculation mode with the valve 768 properly set for this operation, at the preselected slurry flow rate of 30 oz per minute (1,000 lbs per minute/(100 lbs)×3 oz).

In order to initiate the seed coating operation, the slide gate assembly 112 of the pre-filled seed bin 34 is opened by activation of the associated piston and cylinder assembly 122, which permits a quantity of seeds to freely gravitate into the hopper assembly 320, through the openings 344, 346 and 396, 398 above the seed metering wheel, which in this case is the previously described eight-pocket seed wheel; the proximity sensors 388 and 390 confirm the presence of the seed. The system uses an initialized value for the cup weight, for example 3.65 lbs, which is an average cup weight for seeds not previously treated by the system. The rotation of seed wheel is begun by activation of the motor 364. Theoretically, one revolution of the seed wheel should deliver 146 lbs of seed (3.65 lbs per cup=2.5 cups per pocket=16 delivered pockets per wheel revolution 146 lbs). The weight of seed in the bin 34 is then checked to determine the actual weight of seed delivered during the first wheel revolution, say, 450 lbs. This means that 150 lbs of seed was actually delivered, rather than the theoretically calculated 146 lbs. At this point, the control assembly 6 operates to calculate a new cup to pocket factor. The 150 lbs of actually delivered seeds is divided by the theoretical seed delivery of 146 lbs to create a correction factor of 1.0274. Then, this correction factor is multiplied by the cup to pocket factor of 2.5. This gives a new cup to pocket factor of 2.5685 cups per pocket for this seed type. During these steps, the rotation of turret 140 is begun by actuation of drive motor 180, to begin the sequential delivery of seed to the other two, initially empty bins 34.

The cup to pocket factor is adjusted and stored in memory so that future iterations of the program will be able to incorporate a cup weight into each seed profile, which will allow the operator to perform a pre-run calibration with the cup weight specific for the seed profile. Cup weight multiplied by the cup to pocket factor equals the weight of seed in each seed wheel pocket, so that adjusting either the cup weight of cup to pocket factor will give the best result.

At the same time, the valve 768 is reset to its normal calibrated delivery mode of operation, and the pumping assembly 790 is started. Accordingly, seed is delivered through the wheel and passes through atomizer 314 for coating, with ultimate drying in drum 316.

The delivery of slurry is begun using the initially selected flow rate for 10 seconds. According to the initial flow rate, 5 oz of slurry (30 oz per 60 seconds×10 seconds=5 oz) should be delivered, or 0.625 lbs (5 oz slurry 8 oz per lb 0.625 lbs). The actual slur flow rate is determined as compared with the initially selected flow rate. This is done by reading the pump stand scale output and then calculating the actual flow rate. For example, if the scale reading is 499.5 lbs after 10 seconds, only 4.5 lbs of slurry has been actually delivered, versus the 5 lbs predicted by the initial setting. Thereupon, the flow meter 722 is re-calibrated by dividing 0.625 lbs by 0.5 lbs, giving a correction factor of 1.25. This factor is multiplied by the chemical profile's calibration factor, which is assumed to be 1 to give a new chemical calibration factor of 1.25. The control assembly 6 then operates to speed up the flow of liquid until the flow meter reports a flow rate of 37.5 oz per minutes (30 oz per minute×1.25=37.5 oz per minute). The output of the control assembly will report the desired flow rate of 30 oz per minute by using the flow meter reading of 37.5 oz per minute and dividing it by the 1.25 correction factor.

The seed flow rate and liquid flow rate are periodically re-calibrated during the seed treatment run to ensure the most accurate results. The system 1 is then fully calibrated and the cup weight and flow meter correction factors are stored in system memory so that these can be called up and used as initial conditions when the same type of seed is treated in the system 1.

A particular feature of this mode of operation is that the seed wheel and flow meter operation can be successively re-calibrated during operation, rather than only a post-operation re-calibration, as is common in the art.

We claim:

1. A system for coating seeds with a liquid, the system comprising:
a seed bin assembly including a seed bin for containing the seeds, an outlet device for transferring a quantity of the seeds from the seed bin, and a seed weight sensor for determining a weight of the seeds in the seed bin;
a seed metering assembly for metering the transfer of the quantity of the seeds, wherein the seed metering assembly meters the quantity of the seeds as a plurality of subquantities of the seeds;
a liquid delivery assembly for transferring a quantity of the liquid from a reservoir of the liquid;
a coating apparatus for receiving the quantity of the seeds and the quantity of the liquid, and including an atomizer for applying the quantity of the liquid to the quantity of the seeds, and a drum dryer for drying the coated seeds; and
an electronic control assembly configured to operate the seed bin assembly and the seed metering assembly in the following selectable modes
a first mode involving determining an actual amount of the quantity of the seeds transferred from the seed bin based on a change in the weight of the seed remaining in the seed bin after each transfer as indicated by the seed weight sensor, and adjusting operation of the seed metering assembly so that the actual amount of the quantity of the seeds matches an expected amount of the quantity of the seeds, and
a second mode involving determining an actual amount of each subquantity of the seeds included in the quantity of seeds transferred from the seed bin based on a change in the weight of the seed remaining in the seed bin after each transfer as indicated by the first weight sensor, and adjusting operation of the seed metering assembly to account for a difference between the actual amount of the subquantity of the seeds and an expected amount of the subquantity of the seeds.

2. The system as set forth in claim 1, wherein the seed bin assembly includes a plurality of adjacent seed bins.

3. The system as set forth in claim 1, wherein the outlet device is a sliding gate configured to slide between a first position in which the quantity of the seeds flows from the seed bin assembly to the coating apparatus, and a second position in which the quantity of the seeds does not flow to the coating apparatus, and wherein the electronic control assembly is further configured to control movement of the sliding gate between the first position and the second position.

4. The system as set forth in claim 1, wherein the seed metering assembly includes a rotatable seed wheel having a plurality of pockets, and wherein each pocket is configured to define the subquantity of the seeds.

5. The system as set forth in claim 4, wherein adjusting operation of the seed metering assembly includes adjusting a speed of rotation of the rotatable seed wheel.

6. The system as set forth in claim 1, wherein the electronic control assembly is further configured to operate the seed bin assembly and the seed metering assembly in a third mode which involves performing both the first mode and the second mode.

7. A system for coating seeds with a liquid, the system comprising:
a seed bin assembly including a seed bin for containing the seeds, an outlet device for transferring a quantity of the seeds from the seed bin, and a first weight sensor for determining a weight of the seeds in the seed bin;
a seed metering assembly for metering the transfer of the quantity of the seeds;
a liquid delivery assembly including a valve and a pump for transferring a quantity of the liquid from a reservoir of the liquid, a flow metering assembly for metering the transfer of the quantity of the liquid, and a liquid weight sensor for determining; the weight of liquid in the reservoir;
a coating apparatus for receiving the quantity of the seeds and the quantity of the liquid, and including an atomizer for applying the quantity of the liquid to the quantity of the seeds, and a drum dryer for drying the coated seeds; and
an electronic control assembly configured to operate the liquid delivery assembly in the following selectable modes
a first mode involving determining an actual amount of the liquid transferred from the reservoir based on a change in the weight of the liquid remaining in the reservoir after each transfer as indicated by the liquid weight sensor, and adjusting operation of the flow metering assembly so that the actual amount of the quantity of the liquid matches an expected amount of the quantity of the liquid, and
a second mode involving determining an actual flow rate of the transfer of the liquid from the reservoir, and adjusting operation of the liquid delivery assembly to account for a difference between the actual flow rate and an expected flow rate.

8. The system as set forth in claim 7, wherein the seed bin assembly includes a plurality of adjacent seed bins.

9. The system as set forth in claim 7, wherein the outlet device is a sliding gate configured to slide between a first position in which the quantity of the seeds flows from the seed bin assembly to the coating apparatus, and a second position in which the quantity of the seeds does not flow to the coating apparatus, and wherein the electronic control assembly is further configured to control movement of the sliding gate between the first position and the second position.

10. The system as set forth in claim 7, wherein adjusting operation of the liquid delivery assembly includes adjusting one or both of a position of the valve and a speed of the pump.

11. The system as set forth in claim 7, wherein the electronic control assembly is further configured to operate the liquid delivery assembly in a third mode which involves performing both the first mode and the second mode.

12. A system for coating seeds with a liquid, the system comprising:
a seed bin assembly including a seed bin for containing the seeds, an outlet device for transferring a quantity of the seeds from the seed bin, and a seed weight sensor for determining a weight of the seeds in the seed bin;
a seed metering assembly for metering the transfer of the quantity of the seeds, wherein the seed metering assembly meters the quantity of the seeds as a plurality of subquantities of the seeds;
a liquid delivery assembly including a valve and a pump for transferring a quantity of the liquid from a reservoir of the liquid, a flow metering assembly for metering the transfer of the quantity of the liquid, and a liquid weight sensor for determining the weight of liquid in the reservoir;
a coating apparatus for receiving the quantity of the seeds and the quantity of the liquid, and including an atomizer for applying the quantity of the liquid to the quantity of the seeds, and a drum dryer for drying the coated seeds; and
an electronic control assembly configured to
operate the seed bin assembly and the seed metering assembly in the following selectable modes
a first mode involving determining an actual amount of the quantity of the seeds transferred from the seed bin based on a change in the weight of the seed remaining in the seed bin after each transfer as indicated by the seed weight sensor, and adjusting operation of the seed metering assembly so that the actual amount of the quantity of the seeds matches an expected amount of the quantity of the seeds, and
a second mode involving determining an actual amount of each subquantity of the seeds included in the quantity of seeds transferred from the seed bin based on a change in the weight of the seed remaining in the seed bin after each transfer as indicated by the first weight sensor, and adjusting operation of the seed metering assembly to account for a difference between the actual amount of the subquantity of the seeds and an expected amount of the subquantity of the seeds, and
operate the liquid delivery assembly in the following selectable modes
a third mode involving determining an actual amount of the liquid transferred from the reservoir based on a change in the weight of the liquid remaining in the reservoir after each transfer as indicated by the liquid weight sensor, and adjusting operation of the flow metering assembly so that the actual amount of the quantity of the liquid matches an expected amount of the quantity of the liquid, and
a fourth mode involving determining an actual flow rate of the transfer of the liquid from the reservoir, and adjusting operation of the liquid delivery assembly to account for a difference between the actual flow rate and an expected flow rate.

13. The system as set forth in claim 12, wherein the seed bin assembly includes a plurality of adjacent seed bins.

14. The system as set forth in claim 12, wherein the outlet device is a sliding gate configured to slide between a first position in which the quantity of the seeds flows from the seed bin assembly to the coating apparatus, and a second position in which the quantity of the seeds does not flow to the coating apparatus, and wherein the electronic control assembly is further configured to control movement of the sliding gate between the first position and the second position.

15. The system as set forth in claim 12, wherein the seed metering assembly includes a rotatable seed wheel having a plurality of pockets, and wherein each pocket is configured to define the subquantity of the seeds.

16. The system as set forth in claim 15, wherein adjusting operation of the seed metering assembly includes adjusting to speed of rotation of the rotatable seed wheel.

17. The system as set forth in claim 12, wherein the electronic control assembly is further configured to operate the seed bin assembly and the seed metering assembly in a fifth mode which involves performing both the first mode and the second mode.

18. The system as set forth in claim 12, wherein the electronic control assembly is further configured to operate the liquid delivery assembly in a sixth mode which involves performing both the fourth mode and the fifth mode.

19. The system as set forth in claim 12, wherein the electronic control assembly is further configured to operate the liquid delivery assembly in a seventh mode which involves performing at least one of the first mode and the second mode and at least one of the third mode and fourth mode.

20. The system as set forth in claim 12, wherein the electronic control assembly is further configured to operate the liquid delivery assembly in an eighth mode which involves performing all of the first mode, the second mode, the third mode, and the fourth mode.
